(19) United States
(12) Patent Application Publication
(10) Pub. No.: US 2026/0364927 A1
(43) Pub. Date: Nov. 19, 2026

(54) COMPOSITE MATERIAL INCLUDING FIBER-BRIDGING AND METHOD FOR BONDING THERMOPLASTIC-BASED MATERIAL TO FIBER-REINFORCED POLYMER COMPOSITES VIA FIBER-BRIDGING

(71) Applicant: SAUDI ARABIAN OIL COMPANY, Dhahran (SA)

(72) Inventors: Thibault Villette, Belfort (FR); Abderrazak Traidia, Dhahran (SA); Abdullah Al-Shahrani, Dhahran (SA); Chris Worrall, Cambridge (GB); Pedro De Sousa Santos, Ely (GB)

(73) Assignees: SAUDI ARABIAN OIL COMPANY, Dhahran (SA); TWI Ltd., Cambridge (GB)

(21) Appl. No.: 19/207,431

(22) Filed: May 14, 2025

(51) Int. Cl. B32B 27/08; B32B 1/00; B32B 5/12; B32B 27/20; B32B 27/28; B32B 27/38; B32B 37/04; B32B 37/06; B32B 37/08; B32B 37/10; B32B 38/00

(52) U.S. Cl. CPC B32B 27/08; B32B 1/00; B32B 5/12; B32B 27/20; B32B 27/286; B32B 27/288; B32B 27/38; B32B 37/04; B32B 37/06; B32B 37/08; B32B 37/10; B32B 38/0012; B32B 2038/0016; B32B 2262/101; B32B 2305/10; B32B 2305/72; B32B 2307/514; B32B 2309/04; B32B 2363/00; B32B 2371/00; B32B 2386/00; B32B 2398/10

(57) ABSTRACT

A composite material includes a fiber-reinforced polymer composite and a thermoplastic-based material. The fiber-reinforced polymer composite includes a polymer resin, and reinforcement fibers partially embedded in the polymer resin. A portion of the fiber-reinforced polymer composite surface is in contact with a portion of the thermoplastic-based material surface. Ends of the reinforcement fibers are embedded in the thermoplastic-based material. A portion of the reinforcement fibers excluding the embedded portion in the thermoplastic-based material is embedded in the polymer resin. A method for bonding a thermoplastic-based material to a fiber-reinforced polymer composite includes removing a portion of the polymer resin from the fiber-reinforced polymer composite to expose reinforcement fibers. The method also includes heating the thermoplastic-based material to a bonding temperature, contacting the thermoplastic-based material to the exposed reinforcement fibers, embedding the exposed reinforcement fibers in the thermoplastic-based material, and cooling the composite material under pressure to ambient temperature or lower.

### BACKGROUND

A fiber-reinforced thermoset composite (“TSC”) which includes a plurality of reinforcement fibers and cured thermoset polymer resin possesses attractive properties and used in various industries including hydrocarbon transportation, aerospace and automotive. However, because curing of a thermosetting polymer resin is an irreversible process, a TSC is not weldable and therefore, obtaining strong joints of TSCs may be challenging. Un-weldable properties of TSCs may restrain the applicability and performance of the TSC.

A thermoplastic polymer (“TP”) is a polymer that can be melted and re-solidified by increasing and decreasing the temperature of the TP. Therefore, TP resin and a fiber-reinforced thermoplastic composite (“TPC”), which includes a plurality of reinforcement fibers and TP resin, can be welded by heating the TP. Furthermore, TP and TPC may be welded to TSC to produce a TSC with improved surface properties or functionalize the TSC surface to weld other components. TP and TPC may also be used to bond TSC components.

However, in bonding TSC with TP or TPC, the adhesive bonds between the cured thermoset polymer resin and TP resin remain weak. A joint in which TP resin is used as the adhesive relies on weak secondary chemical bonds between the TSC and TP and therefore, the adhesive bond strength is inherently low.

An uncured thermosetting polymer resin can be applied on the surfaces of TSC and TP or TPC and cure the thermosetting polymer resin to bond the TSC and TP or TPC. However, in such a case, the density of bonding sites has to be promoted by treating the surface of TP or TPC, either with a chemical agent or by physical means such as plasma treatment, which can be time-consuming, complex, expensive, and sensitive to change in environmental conditions. Even then, such process may not provide adequate strength or reliability for applications in which the performance of the material is paramount, such as transportation of highly hazardous chemicals or assembly of aircraft components.

Alternative methods of improving the TSC and TP bonding include enhancement to the bond strength via formation of a semi-interpenetrating polymer network, which provides a form of mechanical interlock between the polymer chains of different polymers, such as thermosetting and thermoplastic polymers, by having the chains of one polymer interpenetrating the other. However, such a method has limitations including restricted material choice due to constraint on glass transition temperature compatibility, and potential degradation of a cured thermoset polymer due to the temperature requirement that exceeds the Tg of the cured thermoset polymer. Accordingly, there exists a need for improved bonding properties between TSC and TP and/or TPC, and improved methods for bonding TSC and TP/TPC.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a composite material including a fiber-reinforced polymer composite and a thermoplastic-based material. The fiber-reinforced polymer composite includes a polymer resin including at least one selected from the group consisting of a cured thermoset resin and a thermoplastic resin, and a plurality of reinforcement fibers partially embedded in the polymer resin. At least a portion of the fiber-reinforced polymer composite surface is in contact with at least a portion of a thermoplastic-based material surface. The end portion of at least a portion of the plurality of the reinforcement fibers comprised in the fiber-reinforced polymer composite is embedded in the thermoplastic-based material. A portion of the plurality of reinforcement fibers excluding the end portion embedded in the thermoplastic-based material is embedded in the polymer resin of the fiber-reinforced polymer composite.

In another aspect, embodiments disclosed herein relate to a method for bonding a thermoplastic-based material to a fiber-reinforced polymer composite. The method includes removing a portion of a polymer resin from the fiber-reinforced polymer composite to expose a portion of a plurality of reinforcement fibers of the fiber-reinforced polymer composite, heating at least a portion of the thermoplastic-based material to a bonding temperature, contacting the heated portion of the thermoplastic-based material to the exposed portion of the plurality of the reinforcement fibers and embedding at least a portion of the exposed portion of the plurality of the reinforcement fibers in the thermoplastic-based material, and cooling the fiber-reinforced polymer composite and the thermoplastic-based material under pressure to an ambient temperature or lower.

In another aspect, embodiments disclosed herein relate to a method for bonding a thermoplastic-based material to a fiber-reinforced polymer composite. The method includes machining a portion of the fiber-reinforced polymer composite to produce a tapered portion having a taper angle of greater than 0 degree and 90 degrees or less, removing a portion of a polymer resin in the machined portion of the fiber-reinforced polymer composite by abrasion to expose a portion of a plurality of reinforcement fibers comprised in the fiber-reinforced polymer composite, heating at least a portion of the thermoplastic-based material to a bonding temperature, contacting the heated portion of the thermoplastic-based material to the exposed portion of the plurality of the reinforcement fibers and embedding at least a portion of the exposed portion of the plurality of the reinforcement fibers in the thermoplastic-based material, and cooling the fiber-reinforced polymer composite and the thermoplastic-based material under pressure to an ambient temperature or lower.

Other aspects and advantages of the claimed subject matter will be apparent from the following description and the appended claims.

### BRIEF DESCRIPTION OF THE DRAWINGS

FIG. 1 is a schematic diagram of a composite material according to one or more embodiments.

FIG. 2 is a schematic diagram of a composite material according to one or more embodiments.

FIG. 3 is a schematic diagram of a composite material according to one or more embodiments.

FIG. 4 is a schematic diagram of a composite material according to one or more embodiments.

FIG. 5 is a schematic diagram of a composite material according to one or more embodiments.

FIGS. 6A-6C are schematic diagrams of a composite material having a tapered portion with a taper angle θ, according to one or more embodiments.

FIG. 7 is a schematic diagram of a composite material according to one or more embodiments.

FIG. 8 is graph of a number of fibers per mm² with respect to a taper angle θ of a composite material according to one or more embodiments.

FIGS. 9A-9B are flow diagrams of a method for bonding a thermoplastic-based material to a fiber-reinforced polymer composite via fiber-bridging according to one or more embodiments.

FIGS. 10A-10C are schematic diagrams of a method for bonding a thermoplastic-based material to fiber-reinforced polymer composite via fiber-bridging according to one or more embodiments.

FIG. 11 is a schematic diagram showing a resin removal step of the method for bonding a thermoplastic-based material to a fiber-reinforced polymer composite via fiber-bridging according to one or more embodiments.

FIGS. 12A-12B are schematic diagrams showing an abrasion angle φ for the method for bonding a thermoplastic-based material to a fiber-reinforced polymer composite via fiber-bridging according to one or more embodiments.

FIG. 13 a schematic diagram showing a contacting step of the method for bonding a thermoplastic-based material to a fiber-reinforced polymer composite via fiber-bridging according to one or more embodiments.

FIGS. 14A-14C are schematic diagrams showing a repaired fiber-reinforced polymer composite by the method for bonding a thermoplastic-based material to a fiber-reinforced polymer composite via fiber-bridging according to one or more embodiments.

FIGS. 15A-15B are schematic diagrams providing a cross-sectional view of a test sample of EXAMPLE 1 according to one or more embodiments.

FIGS. 16A-16B are schematic diagrams of a test sample of EXAMPLE 1 according to one or more embodiments.

FIGS. 17A-17B are schematic diagrams of the push-out test push-out test rig.

FIG. 18A is a load vs displacement graph of EXAMPLE 1 subjected to the push-out test, according to one or more embodiments.

FIG. 18B is an apparent stress vs. nominal strain graph of EXAMPLE 1 subjected to the push-out test, according to one or more embodiments.

FIGS. 19A-19H are photographs of EXAMPLE 1 subjected to the push-out test, according to one or more embodiments.

FIG. 20 is a numerical model of EXAMPLE 2 according to one or more embodiments.

FIG. 21 is a schematic diagram showing the displacement condition of EXAMPLE

2 according to one or more embodiments.

FIG. 22 is a numerical model of COMPARATIVE EXAMPLES 1-2.

FIG. 23 is a shear stress vs. shear strain graph of EXAMPLE 2 according to one or more embodiments and COMPARATIVE EXAMPLES 1-2.

FIG. 24 is an equivalent average stress vs. shear strain graph of EXAMPLE 2 according to one or more embodiments and COMPARATIVE EXAMPLES 1-2

FIG. 25 is a numerical model of EXAMPLE 2 under load, according to one or more embodiments according to one or more embodiments.

FIG. 26 is a numerical model of COMPARATIVE EXAMPLE 1 under load.

FIG. 27 is a numerical model of COMPARATIVE EXAMPLE 2 under load.

FIG. 28 is a magnified view of the numerical model of EXAMPLE 2 under load according to one or more embodiments.

FIG. 29 a magnified view of the numerical model of EXAMPLE 2 under load according to one or more embodiments.

FIG. 30 is a graph showing experimental shear strength of EXAMPLE 1 according to one or more embodiments, REFERENCE EXAMPLE 1 and REFERENCE EXAMPLE 2.

FIG. 31 a graph showing numerical shear strength of EXAMPLE 2 according to one or more embodiments, COMPARATIVE EXAMPLE 1 and COMPARATIVE EXAMPLE 2.

### DETAILED DESCRIPTION

The present disclosure generally relates to a composite material including a fiber-reinforced polymer composite and a thermoplastic-based material. The fiber-reinforced polymer composite includes a polymer resin and a plurality of reinforcement fibers partially embedded in the polymer resin. At least a portion of the fiber-reinforced polymer composite surface included in the composite material is in contact with at least a portion of the thermoplastic-based material surface, and an end portion of at least a portion of the plurality of the reinforcement fibers included in the fiber-reinforced polymer composite is embedded in the thermoplastic-based material.

FIG. 1 shows an exemplary composite material of one or more embodiments having a single bonding surface 120 between a fiber-reinforced polymer composite and a thermoplastic-based material. A composite material 100 includes a fiber-reinforced polymer composite 102 and a thermoplastic-based material 108. The fiber-reinforced polymer composite 102 includes a polymer resin 106 and a plurality of reinforcement fibers 104 partially embedded in the polymer resin 106. At least a portion of the surface of the fiber-reinforced polymer composite 102 is in contact with at least a portion of the surface of the thermoplastic-based material 108. An end portion 110 of the at least a portion of the reinforcement fibers 104 included in the fiber-reinforced polymer composite 102 is embedded in the thermoplastic-based material 108. A portion of the plurality of reinforcement fibers 104 excluding the end portion 110 embedded in the thermoplastic-based material 108 is embedded in the polymer resin 106 of the fiber-reinforced polymer composite 102. The fiber-reinforced polymer composite 102 is strongly attached to the thermoplastic-based material 108 because the end portion 110 of the reinforcement fibers 104 is embedded in the thermoplastic-based material 108. This embedding of the fibers in both the polymer resin and the thermoplastic-based material is referred to herein a “fiber-bridging”.

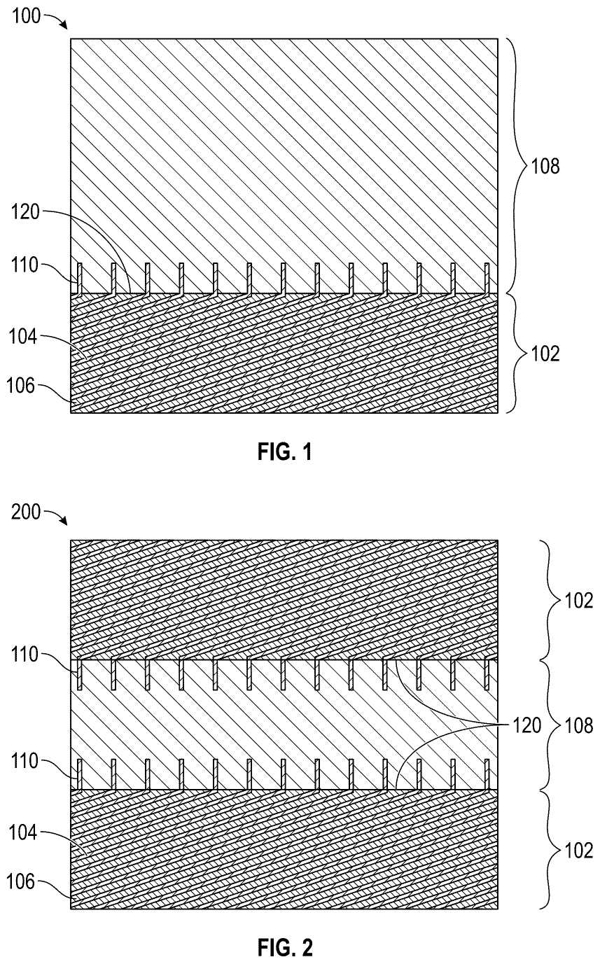

FIGS. 2-4 represent exemplary composite materials of one or more embodiments including a fiber reinforced polymer composite and a thermoplastic-based material having various geometrical shapes. Similar to FIG. 1, the composite material 200, 300 and 400 includes a fiber-reinforced polymer composite 102 including a plurality of reinforcement fibers 104 and a polymer resin 106, and a thermoplastic-based material 108. At least a portion of the surface of the fiber-reinforced polymer composite 102 is in contact with at least a portion of the surface of the thermoplastic-based material 108. An end portion of the at least a portion of the reinforcement fibers 104 included in the fiber-reinforced polymer composite 102 is embedded in the thermoplastic-based material 108.

The composite material 200 in FIG. 2 represents one or more embodiments having a plurality of bonding surfaces 120 between two fiber-reinforced polymer composites 102 and a thermoplastic-based material 108.

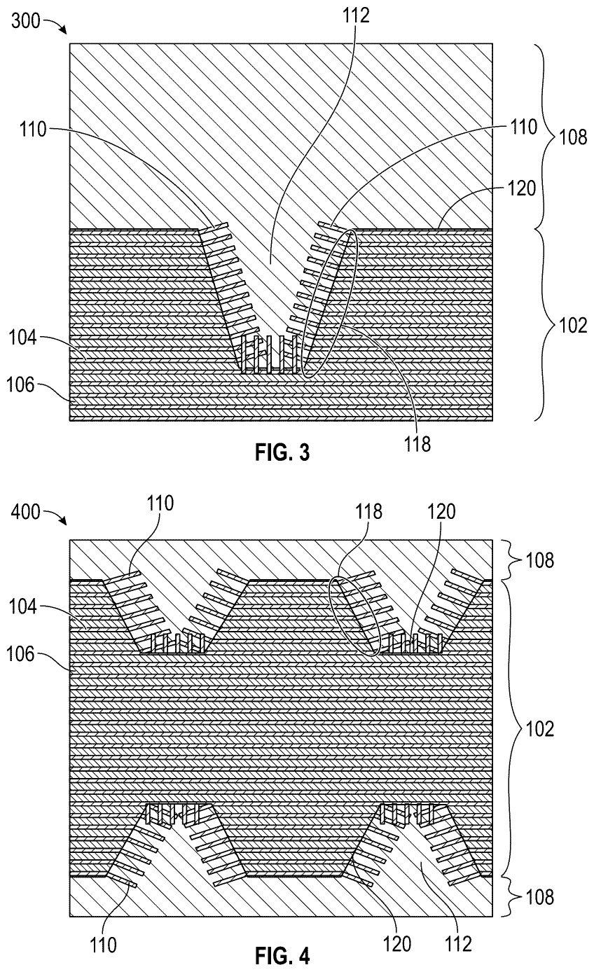

The composite material 300 in FIG. 3 represents a composite material of one or more embodiments having a single bonding surface 120 between a fiber-reinforced polymer composite 102 and a thermoplastic-based material 108 and having a “pin weld,” in which a portion of the fiber-reinforced polymer composite 102 has a recessed portion 112 and the thermoplastic-based material 108 fills the recessed portion 112. The pin weld configuration increases the surface area of the portion of the fiber-reinforced polymer composite 102 that is in contact with the thermoplastic-based material 108 and may result in improved adhesion between the fiber-reinforced polymer composite 102 and the thermoplastic-based material 108. The fiber-reinforced polymer composite 102 has a tapered portion 118 having a specific taper angle. The specifics of the tapered portion are provided in the subsequent section.

The composite material 400 in FIG. 4 represents one or more embodiments having a plurality of bonding surfaces 120 between two fiber-reinforced polymer composites 102 and a thermoplastic-based material 108 and has the pin weld configuration in which the fiber-reinforced polymer composite 102 has recessed portions 112 filled with the thermoplastic-based material 108. Similar to FIG. 3, the fiber-reinforced polymer composite 102 has a tapered portion 118.

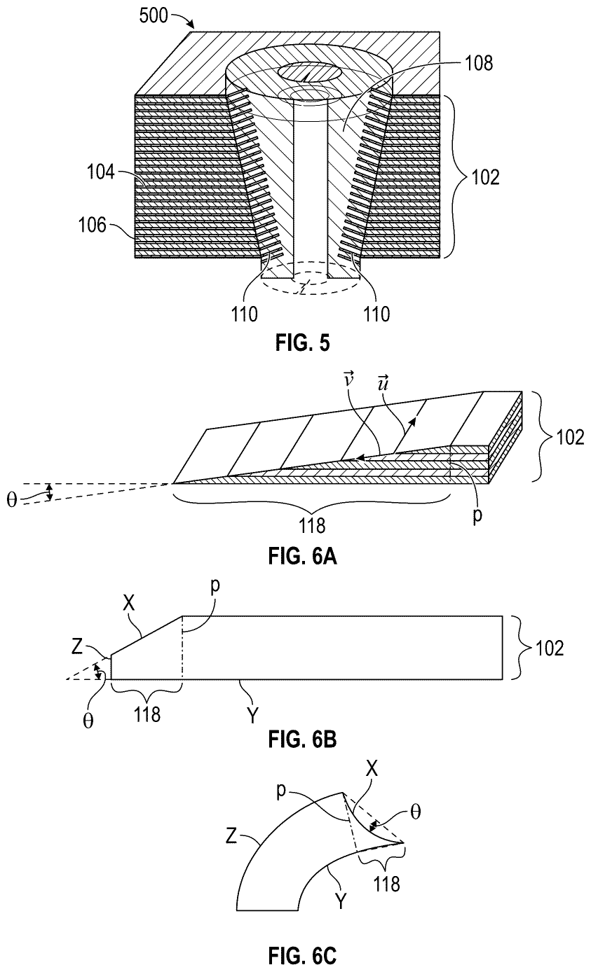

FIG. 5 illustrates an exemplary composite material that is a thermoplastic insert welded to a fiber-reinforced polymer composite 102. The features shown in the composite material 500 are as described in FIGS. 1-4. The thermoplastic insert weld of the composite material 500 may be produced, for example, by using rotary friction welding. Such welded connection between the fiber-reinforced polymer composite 102 and the thermoplastic-based material 108 may provide a robust fixed point for further assembly with other components, integration of sensors, and fluid conduits, for example. The dimensions, geometry, and scale of such insert may be adjusted based on the specific requirements of the target application.

### Fiber-Reinforced Polymer Composite

In one or more embodiments, the composite material includes a fiber-reinforced polymer composite including a plurality of reinforcement fibers and a polymer resin. The plurality of the reinforcement fibers are partially embedded in the polymer resin.

### Reinforcement Fibers

The plurality of reinforcement fibers 104 included in the fiber-reinforced polymer composite 102 may be continuous fibers, non-continuous fibers or combinations thereof. In the present disclosure, “continuous fibers” included in the fiber-reinforced polymer composite 102 refer to fibers that have a length to diameter ratio (“aspect ratio”) of 1000 or greater. “Non-continuous fibers” included in the fiber-reinforced polymer composite 102 refer to fibers that have an aspect ratio of less than 1000. Non-continuous fibers may be “short fibers” having a length of approximately 0.2 mm, may be “long fibers’ having a length in a range of about 0.5 mm to 5 mm, such as 2 mm, or may be “discontinuous fibers” having a length in a range of greater than 5 mm to about 10 cm. Examples of a fiber-reinforced polymer composite including non-continuous fibers include HexMC® Molding Composite available from Hexcel Corporation.

Each of the plurality of reinforcement fibers 104 may have a diameter in a range of about 5 micrometers (μm) to about 25 μm. The plurality of reinforcement fibers 104 may be provided in a form of yarn or roving, which are an assembly of individual reinforcement fibers 104.

Examples of fiber-reinforced polymer composite 102 having non-continuous reinforcement fibers may include, but are not limited to, a bulk molding compound (BMC), Stamax™ long fiber reinforced thermoplastic composite material available from Sabic, and a short fiber reinforced thermoplastic composite such as Fortron 1141L4 40% short glass fiber filled polyphenyl sulfide available from Celanese Corporation, an example of GF-PPS.

The reinforcement fibers 104 in the fiber-reinforced polymer composite 102 may be provided as continuous fibers or roving directly from bobbins, or may be provided from an intermediate fibrous materials. The intermediate fibrous materials may include textile or fabric reinforcements such as woven fabric, knitted fabric, stitch-bonded fabric, non-woven fabric, and resin-impregnated fibrous materials (“prepregs”) in which the reinforcement fibers and uncured thermoset polymer resin or TP resin are combined prior to the production of the fiber-reinforced polymer composite. The fabric reinforcement may be two-dimensional, three-dimensional, or may be a “pre-form” which the unimpregnated fibers are put together to have a shape that is similar to the shape of the part to be produced.

The prepreg may include a thermoset prepreg in which the reinforcement fibers are impregnated with uncured thermoset polymer resin, or a thermoplastic prepreg, in which the reinforcement fibers are impregnated with a TP resin. The prepregs may be a “unidirectional tape” in which the reinforcement fibers are parallel or substantially parallel to each other, or a fabric prepreg in which any of the aforementioned fabric is impregnated with a polymer resin. Fibers that are “substantially parallel” means that the fibers are aligned such that the angle formed by two individual fibers is less than 5°, less than 4°, less than 3°, less than 2°, less than 1°, or less than 0.5°. The prepreg may be produced substantially in advance prior to the production of the fiber-reinforced polymer composite 102, may be partially cured (“B-staged”), in case of a thermoset prepreg, and may be capable of being stored long term. The prepreg may be produced immediately prior to the production of the fiber-reinforced polymer composite 102 and the polymer resin may be uncured, or marginally cured, in case of a thermoset prepreg (“wet preg”). The width, areal weight, and fiber and resin content of the intermediate fibrous material may be determined based on the requirements of specific applications. The reinforcement fibers in the prepreg may be fully impregnated by the polymer resin or partially impregnated (“semi-preg”).

The reinforcement fibers may be “randomly oriented,” in which the reinforcement fibers 104 are placed within the fiber-reinforced polymer composite 102 without specific directionality (“orientation”), in which the reinforcement fibers 104 are placed within the fiber-reinforced polymer composite 102 in at least one specific direction, or a combination of randomly oriented and oriented fibers. “Substantially oriented” fibers refer to fibers which are sufficiently parallel to each other such that the angle difference between any two fibers within the substantially oriented fibers is less than 5 degrees, less than 4 degrees, less than 3 degrees, less than 2 degrees, less than 1 degree, less than 0.5 degree, or 0 degrees.

Oriented reinforcement fibers may be provided by using, for example, aforementioned continuous fibers or roving from a bobbin, or intermediate fibrous material.

A fiber-reinforced polymer composite 102 including oriented short fibers may be produced, for example, via injection molding process, in which the fibers may align at and near the vicinity of the mold surface in the direction of the resin flow.

Examples of the reinforcement fibers 104 included in the fiber-reinforced polymer composite may include, but are not limited to, glass fiber (E-glass, high strength glass), quartz fiber, carbon fiber, aramid fiber, boron fiber, basalt fiber, silicon carbide (SiC) fiber, poly (p-phenylene-2,6-benzobisoxazole (PBO) fiber (e.g., Zylon® available from Toyobo Co., Ltd.), metallic fibers including steel, copper, aluminum, nickel, gold, silver and titanium, thermoplastic fibers such as polyester, polyamide, liquid crystal polymer (LCP), (e.g., Vectran™ available from Kuraray Co., Ltd), polyolefin (e.g., ultra high molecular weight polyethylene (UHMWPE) and polypropylene), fibers obtained from plants including wood, cotton, sisal, flax, jute, hemp, coconut, bamboo, and combinations of any of the fibers above. The reinforcement fibers 104 may be coated fibers coated with a polymer, metal, ceramic, or combinations thereof.

### Polymer Resin

In one or more embodiments, the polymer resin 106 included in the fiber-reinforced polymer composite 102 is a cured thermoset polymer resin, a thermoplastic polymer (TP) resin, or combinations thereof. A fiber-reinforced polymer composite 102 which includes a plurality of reinforcement fibers 104 and cured thermoset polymer resin is referred to as a fiber-reinforced thermoset composite (TSC), while a fiber-reinforced polymer composite 102 which includes a plurality of reinforcement fibers 104 and a TP resin is referred to as a fiber-reinforced thermoplastic composite (TPC).

A thermoset polymer resin (a curable resin) refers to a polymer or a polymeric composition which is capable of undergoing irreversible chemical reaction (curing process) to alter its properties including mechanical and physical properties. The curing process may include cross-linking of the polymers within the resin. The curing may be initiated at a room temperature, at an elevated temperature, or may be triggered by other stimulus, such as exposure to a visible light or ultraviolet light. The thermoset resin may be in a form of a composition, which may include a curing agent and a polymer that can be cured with the presence of the curing agent. The thermoset resin may be a polymeric resin that is capable of self-curing without the need for a curing agent. Examples of the thermoset resin may include, but are not limited to, benzoxazine resin, bis-maleimide resin (BMI), cyanate ester resin, epoxy (epoxide) resin, phenolic (PF) resin, unsaturated polyester (UP) resin, polyimide resin, polyurethane (PUR) resin, silicone resin, vinyl ester resin, and a composition including any of the aforementioned resins. In one or more embodiments, the cured thermoset polymer resin is a resin that does not degrade at the bonding temperature of the TP resin.

A TP resin refers to a polymer or a polymeric composition which can be melted and solidified without undergoing irreversible chemical reaction. The TP resin may be amorphous, crystalline, or semi-crystalline. Examples of the TP resin may include, but are not limited to, polyolefins (polypropylene, polyethylene), engineering and specialty polymers such as polyamide (PA), polyketone (POK), polyvinylidene fluoride (PVDF), polytetrafluoroethylene (PTFE), polyphenylene sulfice (PPS), polyether ether ketone (PEEK), polyaryletherketone (PAEK), polyetherketoneketone (PEKK), polyethylenimine (PEI), and compositions including any of the above polymers. The TP resin may be supplied in various forms which may include, but are not limited to, beads, particles and fibers, which may be continuous fibers or short fibers.

### Fiber-Reinforced Polymer Composite-Configurations

The fiber-reinforced polymer composite 102 may have a multi-layered (multi-ply, laminate) structure. In a multi-layered structure, the reinforcement fibers 104 may be, within each layer, randomly oriented, oriented in one or more directions, or combinations thereof. A multi-layered fiber-reinforced polymer composite may include layers having randomly oriented fibers, oriented fibers in one or more directions, or combinations thereof. The direction of oriented fibers in each layer may be the same or may be different from layer to layer. For example, the reinforcement fibers 104 in the fiber-reinforced polymer composite 102 may be oriented in one specific direction (unidirectional configuration), or may include layers oriented in a first direction, and layers perpendicular to the first direction (i.e., crossply configuration). In one or more embodiments, the fiber-reinforced polymer composite 102 includes layers with reinforcement fibers 104 oriented in specific angles (“ply angles”). For example, the fiber-reinforced polymer composite 102 may have alternating layers having reinforcement fibers 104 oriented at 55 degrees with respect to a length direction (or a longest dimension) of the composite as the first layer having a first ply angle, and having reinforcement fibers 104 oriented at −55 degrees with respect to the length direction as the second layer having a second ply angle, which is different from the first ply angle, and the alternating layup may be repeated (e.g., third layer having the first ply angle, forth layer having the second ply angle). The specific layer configurations and fiber orientations may be selected based on the requirements of a specification application. In one or more embodiments, the first ply angle is in a range of from about 0 degrees to about 90 degrees, such as in a range of greater than 0 degrees to less than 90 degrees, or from a lower limit selected from any one of 0, 1, 5, 10, 20, 30, 45 and 55 degrees to an upper limit selected from any one of 60, 70, 80 85, 89 and 90 degrees, where any lower limit may be paired with any upper limits. In one or more embodiments, the second ply angle is in a range of from about 0 degrees to about −90 degrees, such as in a range of greater than 0 degrees to less than −90 degrees, or from a lower limit selected from any one of 0, −1, −5, −10, −20, −30, −45, and −55 degrees to an upper limit selected from any one of −60, −70, −80, −85, −89 and −90 degrees, where any lower limit may be paired with any upper limits. The lay-up configuration of the multi-layered structure may be symmetrical, or non-symmetrical. A symmetrical lay-up configuration refers to a configuration in which the second half of the lay-up pattern is in the reverse order of the first half, where the first and second half are defined by the center line of the dimension of the fiber-reinforced polymer composite 102 perpendicular to the direction of the plies. For example, a fiber-reinforced polymer composite 102 having 4 layers with ply angles of 0-90-90-0 is considered as having a symmetrical layup where the center line corresponds to the interface of the two 90 degree layers.

In case the fiber-reinforced polymer composite 102 includes reinforcement fibers 104 that are provided from a sheet including a plurality of ply angles, such as woven fabric, or a stitch-bonded fabric, a single sheet would be considered as having a multi-layer structure with a number of layers equal to the number of ply angles, for the purpose of the present disclosure. For example, a woven fabric having reinforcement fibers 104 that are interlaced in the warp and weft directions, or 0 and 90 degrees, where 0 degrees is the roll direction of the fabric, would be considered as having a two-layer structure with two ply angles. Similarly, a stitch bonded fabric which includes reinforcement fibers 104 in the warp direction (0 degrees), weft direction (90 degrees), and in +/−45 degrees would be considered as having a 4-layer structure with 4 ply angles.

In one or more embodiments, the fiber-reinforced polymer composite 102 may have a single-layered structure, or a structure without discrete layers.

The fiber-reinforced polymer composite 102 may be produced by methods known in the art. Such methods may include, but are not limited to, vacuum bagging and autoclave or oven cure, wet-layup, pultrusion, resin infusion/injection (e.g., resin transfer molding (RTM), vacuum-assisted resin transfer molding (VARTM), and film infusion), injection molding, compression molding, automated processes (e.g, automated tape laying (ATL), automated tape placement (ATP)), filament winding, and combinations thereof.

Referring back to FIGS. 3 and 4, in one or more embodiments, the fiber-reinforced polymer composite 102 has a tapered portion 118. A tapered portion 118 of the fiber-reinforced polymer composite 102 refers to a portion of the fiber-reinforced polymer composite 102 that includes a first surface, and a second surface, where the second surface intersects with the first surface at an angle (taper angle θ) of less than 90 degrees, and a nominal plane defined by a longest/widest plane drawn from the first surface and that intersects the second surface perpendicularly (plane p). An example of a tapered portion 118 of the fiber-reinforced polymer composite 102 having a taper angle θ is shown in FIG. 6A, in which the nominal plane p is represented by a long and short dash line.

In case the fiber-reinforced polymer composite 102 has a multilayer structure that is flat in shape, as shown in FIG. 6A, the taper angle θ may be defined as the angle formed by the inclined surface of the tapered portion 118 and the plane parallel to the plies in the fiber-reinforced polymer composite 102.

In the present disclosure, a first surface and a second surface refer to portions of the surfaces that are inclined at different angles. For example, surface X, and surface Y of FIG. 6B may be considered as the first and second surfaces because the angle of inclination for surface X and Y are different. Similarly, surface X and surface Z, or surface Y and surface Z, may be considered as the first and second surfaces.

The fiber-reinforced polymer composite 102 is considered to have a tapered portion 118 if extrapolation of the surfaces intersect at an angle less than 90 degrees. For example, in the fiber-reinforced polymer composite 102 shown in FIG. 6B, surface X only intersects with surface Z, and does not intersect with surface Y. Surfaces X and Z do not intersect at an angle of less than 90 degrees. However, the extrapolation of surface X and surface Y, which is shown with even broken lines, forms a taper angle θ of less than 90 degrees.

In case the surfaces of the fiber-reinforced polymer composite 102 have contours, a portion of the arched surface having continuously-varying tangent angle is considered as a single surface, such as a first surface or a second surface. For example, in the fiber-reinforced polymer composite 102 shown in FIG. 6C, the arc represented by X may be considered as the first surface, and the arc represented by Y may be considered as the second surface. X, Y and Z are distinct surfaces because the tangent angle discontinuously varies where the surface transitions from X to Y, and X to Z. In FIG. 6C, the taper angle θ is defined as the angle obtained by connecting the intersection of the first and the second surfaces (X and Y) and the ends of plane p, which are shown with even broken lines. A surface having a flat portion and a contoured portion is considered as having two distinct surfaces even if the tangent angle continuously varies where the surface transitions from contoured to flat. Thus, as will be appreciated by those skilled in the art, the taper angle described herein may be applied to any specific configuration or geometry of the fiber-reinforced polymer composite 102.

The location for the tapered portion 118 is not specifically limited, and may be located where at least a portion of the fiber-reinforced polymer composite surface included in the composite material is in contact with at least a portion of the thermoplastic-based material surface, and an end portion of at least a portion of the plurality of the reinforcement fibers 104 included in the fiber-reinforced polymer composite 102 is embedded in the thermoplastic-based material 108. In one or more embodiments, the tapered portion 118 is located where the pin weld is being formed, as shown in FIGS. 3 and 4. In one or more embodiments, the tapered portion 118 may be located at the edge of the fiber-reinforced polymer composite 102, as shown in FIG. 6A. The tapered portion 118 may be produced by using a mold having a shape of the tapered portion at the desired locations in producing the fiber-reinforced polymer composite 102. In one or more embodiments, the tapered portion 118 may be produced by machining the fiber-reinforced polymer composite 102. The tapered portion 118 may provide a higher surface area for bonding and a higher number of embedded reinforcement fiber ends in the thermoplastic-based material 108 and contribute the overall adhesive strength improvement between the fiber-reinforced polymer composite 102 and the thermoplastic-based material 108.

In one or more embodiments, the tapered portion 118 has a taper angle θ in a range of greater than 0 degrees and 90 degrees or less. In one or more embodiments, the taper angle is in a range of from a lower limit selected from any one of 0.01, 0.1, 0.5, 1, 2, 2.5 3, 4, 5, 10, 20, 30, 40 and 45 degrees, to an upper limit selected from any one of 10, 20, 30, 40, 45, 50, 60, 70, 80 and 90 degrees, where any lower limit may be paired with any mathematically-compatible upper limit. Increasing the taper angle may increase the number of fiber ends per unit area, but may reduce the total bonding area. The number fiber ends per unit area may be maximized at a taper angle of 90 degrees. Decreasing the taper angle may provide increased bonding surface area, but may reduce the number of fiber ends per unit area. The optimum taper angle may be determined based on the specific requirements of each application by taking the number of fiber ends per unit area and the total bonding area into consideration.

### Thermoplastic-Based Material

In one or more embodiments, the composite material 100 includes a thermoplastic-based material 108. As used herein, a “thermoplastic-based material” is a material that includes a TP resin but may also include additional components. For example, the thermoplastic-based material may be a TP resin as previously described, or a fiber-reinforced thermoplastic composite (TPC) which includes the reinforcement fibers 104 and TP resin as previously described. The thermoplastic-based material may further comprise additives which may be polymeric or non-polymeric. The reinforcement fibers 104 in the TPC are separate from the reinforcement fibers 104 included in the fiber-reinforced polymer composite 102. The reinforcement fibers 104 in the TPC may be the same type of fibers as the reinforcement fibers 104 in the fiber-reinforced polymer composite 102, or may be partially or fully different type of fibers from the reinforcement fibers 104 in the fiber-reinforced polymer composite 102. The TPC may have any of the configurations as previously described for the fiber-reinforced polymer composite 102.

### Fiber-Bridging

In one or more embodiments, at least a portion of the surface of the fiber-reinforced polymer composite 102 included in the composite material 100 is in contact with at least a portion of the surface of the thermoplastic-based material 108 included in the composite material 100. Furthermore, in one or more embodiments, the composite material 100 has a “fiber-bridging” feature, in which an end portion 110 of at least a portion of the plurality of the reinforcement fibers 104 included in the fiber-reinforced polymer composite 102 is embedded in the thermoplastic-based material 108. A composite material having such fiber-bridging feature provides a larger total contact surface between the fiber-reinforced polymer composite 102 and the thermoplastic-based material 108 than a composite material having no fiber-bridging feature. The fiber-bridging improves bonding strengths, including shear strength, between the fiber-reinforced polymer composite 102 and the thermoplastic-based material 108. Exemplary composite materials which includes the fiber-bridging feature are shown in FIGS. 1-5. In the present disclosure, “an end portion” of the plurality of the reinforcement fibers refers to a portion of the reinforcement fibers 104 that includes an end of the reinforcement fiber.

In one or more embodiments, a portion of the plurality of reinforcement fibers 104 excluding the end portion 110 embedded in the thermoplastic-based material is embedded in the polymer resin 106 of the fiber-reinforced polymer composite 102 such that the reinforcement fibers 104 are embedded in both the polymer resin 106 and the thermoplastic-based material 108 to provide the fiber-bridging feature.

In one or more embodiments, the end portion 110 of the at least a portion of the plurality of the reinforcement fibers 104 included in the fiber-reinforced polymer composite 102 that is embedded in the thermoplastic-based material 108 is oriented in a different direction with respect to a portion of the at least a portion of the plurality of the reinforcement fibers 104 embedded in the fiber-reinforced polymer composite 102.

The end portion 110 of the reinforcement fibers 104 that is embedded in the thermoplastic-based material 108 “oriented in a different direction” with respect to a portion of the reinforcement fibers 104 embedded in the fiber-reinforced polymer composite 102 is defined by providing Line A and Line B as follows. “Line A” represents a line obtained by connecting the end of the reinforcement fibers 104 embedded in the thermoplastic-based material 108, and a point of the reinforcement fibers 104 that overlaps with the surface of the thermoplastic-based material 108. “Line B” represents a line obtained by connecting the end of the reinforcement fibers 104 embedded in the fiber-reinforced polymer composite 102 and a point of the reinforcement fibers 104 that overlaps with the surface of the fiber-reinforced polymer composite 102. A configuration in which “Line A” and “Line B” are not parallel based on 3-dimensional coordinates is considered as the end portion 110 oriented in a different direction with respect to the portion of the reinforcement fibers 104 embedded in the fiber-reinforced polymer composite 102.

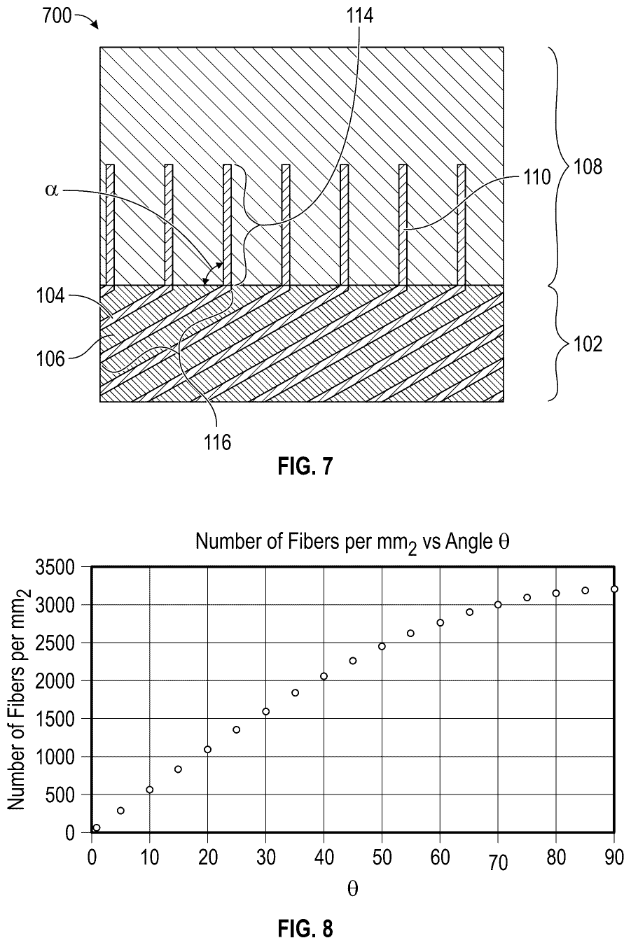

FIG. 7 shows an exemplary composite material in which the end portion 110 of the reinforcement fibers 104 embedded in the thermoplastic-based material 108 is oriented in a different direction with respect to a portion of the reinforcement fibers 104 embedded in the fiber-reinforced polymer composite 102. Similar to the composite material of FIGS. 2-5, the composite material 700 includes a fiber-reinforced polymer composite 102 including a plurality of reinforcement fibers 104 and polymer resin 106, and a thermoplastic-based material 108. The end portion 110 of the plurality of reinforcement fibers 104 is embedded in the thermoplastic-based material 108. Line A and Line B are shown as 114 and 116, respectively. Non-parallel Line A 114 and Line B 116 of FIG. 7 form an angle greater than zero degrees and less than 180 degrees. In such a configuration, the end portion 110 of the reinforcement fibers 104 embedded in the thermoplastic-based material 108 is considered as oriented in a different direction with respect to a portion of the reinforcement fibers 104 embedded in the fiber-reinforced polymer composite 102. The above-mentioned definition applies to the reinforcement fibers that are embedded straight or with curvatures.

In one or more embodiments, the end portion 110 of the reinforcement fibers 104 embedded in the thermoplastic-based material is oriented at an angle α in a range of greater than 0 degrees and about 90 degrees or less with respect to the surface of the fiber-reinforced polymer composite 102 that is in contact with the thermoplastic-based material surface, as shown in FIG. 7. In one or more embodiments, the end portion 110 of the reinforcement fibers 104 embedded in the thermoplastic-based material is oriented at an angle α in a range of 40 degrees or less, 30 degrees or less, 20 degrees or less, 10 degrees or less, 5 degrees or less, 1 degree or less, with respect to the surface of the fiber-reinforced polymer composite 102 that is in contact with the thermoplastic-based material surface. In one or more embodiments, the end portion 110 of the reinforcement fibers 104 embedded in the thermoplastic-based material is oriented at an angle α in a range of from a lower limit selected from any one of 0.01, 0.1, 1, 5, 10, 20, 30, and 40 degrees, to an upper limit selected from any one of 5, 10, 20, 30, 40, 50, 60, 70, 80, 85, 90 degrees, where any lower limit may be paired with any mathematically compatible upper limit. An angle α close to 0, such as 5 degrees or less, or 1 degree or less, may minimize stress localization in the fiber elbow and thus, lead to a higher interfacial bonding strength.

In one or more embodiments, the composite material 100 has a number of the end portion 110 of the reinforcement fibers 104 embedded in the thermoplastic-based material 108 per unit area (a number of fiber ends per unit area) of from about 100 fiber ends per mm² to about 3200 fiber ends per mm². The number of fiber ends per unit area may be determined by obtaining the number of the end portion of the reinforcement fibers embedded in the thermoplastic-based material, and dividing by the surface area of the thermoplastic-based material that is in contact with the fiber-reinforced polymer composite, and where the embedded fibers are present.

In one or more embodiments, the number of fiber ends per unit area, ρ_{surf}, may be determined by the following Equation 1:

$${ρ}_{surf} = \frac{{n}_{\vec{u}} \cdot {n}_{\vec{v}}}{{l}_{\vec{u}} \cdot {l}_{\vec{v}}} = \frac{2 {l}_{p}}{\sqrt{3} {l}_{\vec{u}} {d}_{f}^{2}} = \frac{2 sin θ}{\sqrt{3} {d}_{f}^{2}} \qquad ( Equation 1 )$$

Where n_{\vec{u}} and n_{\vec{v}} are the number of fibers ends available in the \vec{u} and \vec{v} direction, lₚ is the ply thickness, d_{f} is the average distance between fiber axes, l_{\vec{u}}, l_{\vec{v}} are a surface unit, and θ is a taper angle of the tapered portion 118 of the fiber-reinforced polymer composite 102, as previously described. \vec{u} and \vec{v}.directions represent directions on the surface of the tapered portion 118 as shown in FIG. 6A.

FIG. 8 is a graph showing an estimate of the number of fiber ends per unit surface as a function of θ. FIG. 8 shows that a surface machined at 90 degrees from the ply plane can release up to approximately 3200 fiber ends per mm², and when the θ equals to 2.5 degrees, the number of fiber ends is approximately 139 per mm². FIG. 8 indicates that a much higher bonding strength between the fiber-reinforced polymer composite and the thermoplastic-based material may be possible for θ of above 45 degrees than for θ closer to 0 degree.

In one or more embodiments, the end portions 110 of all of the reinforcement fibers 104 included in the fiber-reinforced polymer composite 102 are embedded in the thermoplastic-based material 108. In one or more embodiments, the end portions 110 of a portion of the reinforcement fibers 104 included in the fiber-reinforced polymer composite 102 is embedded in the thermoplastic-based material 108. For example, as shown in FIG. 4, the end portions 110 of the reinforcement fibers 104 of the fiber-reinforced polymer composite 102 in the vicinity of the pin weld are embedded in the thermoplastic-based material 108, while the reinforcement fibers 104 in the middle portion of the fiber-reinforced polymer composite 102 are not embedded in the thermoplastic-based material 108.

The composite material of one or more embodiments may have various geometrical shapes, and the portion of a fiber-reinforced polymer composite surface that is in contact with the thermoplastic-based material surface, and has the fiber-bridging feature may be, and are not limited to, a surface that is planer, cylindrical, conical, concave, convex or random in shape.

A length of the end portion 110 of the reinforcement fibers 104 embedded in the thermoplastic-based material 108 (expressed as L_{ef}) may be determined based on various properties and conditions such as the adhesion properties between the reinforcement fibers 104 and the thermoplastic-based material 108, the number of available reinforcement fibers, and required adhesion properties between the fiber-reinforced polymer composite and the thermoplastic-based material.

The L_{ef} affects the stiffness and strength of the interface, or the bonding strength between the fiber-reinforced polymer composite 102 and the thermoplastic-based material 108. If L_{ef} is insufficient, such configuration may lead to reduced bonding strength because of the reduced total surface area of the reinforcement fibers 104 that is in contact with the thermoplastic-based material 108. If L_{ef} is excessively long, such configuration may provide sufficient bonding strength but the interface may show diminished increase in the bonding strength with respect to the L_{ef}. In other words, there may be a L_{ef} beyond which the bonding strength between the fiber-reinforced polymer composite 102 and the thermoplastic-based material 108 do not increase substantially.

In one or more embodiments, there may be a range of L_{ef} that provides optimum interface performance and bonding strength. Such range of L_{ef} may depend on the aspect ratio “A” of the L_{ef} to the diameter of the reinforcement fibers 104, the angle between of the end portion 110 of the reinforcement fibers 104 embedded in the thermoplastic-based material 108 with respect to the reinforcement fibers 104 embedded in the fiber-reinforced polymer composite 102 and the direction of the applied load (angle “β”), and the number of fiber ends per unit area, ρ_{surf}.

For example, when β=0° (i.e., the reinforcement fibers 104 embedded in the thermoplastic-based material 108 are loaded in their axis direction of the fibers (uniaxial tensile loading)), an aspect ratio A above 1000 may not necessarily provide further strength and stiffness improvement.

For instance, for fibers having a diameter (Ø) of 20 microns, which may represent a typical diameter of an E-glass fiber, L_{ef} greater than 20 mm (1000×20 microns) does not necessarily result in substantial improvement of the interface performance beyond this value. Below this value, the interface properties may be proportional to the aspect ratio A. For fibers having a Ø of 7 microns, which may represent a diameter of a typical carbon fiber, such diminished improvement may be seen when L_{ef} is about 7 mm (1000×7 microns).

When β=90° (i.e, the reinforcement fibers 104 embedded in the thermoplastic-based material 108 are loaded perpendicular to the axis direction of the fibers (fiber shear loading)), L_{ef} may be less influential compared to the number of fiber ends per unit area, β_{surf}, which may increase the interfacial stiffness and strength in a quasi-linear fashion (comparing to the rule of mixture applied to Young's modulus). In such a configuration, the aspect ratio A may be maintained at 50 or greater to avoid fiber debonding during shear load. Furthermore, to account for the irregularity of the interface of the fiber-reinforced polymer composite 102 and the thermoplastic-based material 108, a minimum L_{ef} can be defined as the larger value of 3×tol and fiber diameter×50, where tol may be typically expressed as +/−0.1 mm. For example, the minimum L_{ef} for fibers having a diameter Ø of 20 microns may be 1 mm (the larger value of 0.3 mm (3×0.1 mm) and 1 mm (20 microns×50)), and the minimum L_{ef} for fibers having a diameter Ø of 7 microns may be 0.35 mm (the larger value of 0.3 mm (3×0.1 mm) and 0.35 mm (7 microns×50)).

In one or more embodiments, L_{ef} in the composite material 100 is at least the minimum L_{ef} as defined above. A composite material 100 having L_{ef} below the minimum L_{ef} may lead to reduced bonding strength. In one or more embodiments, L_{ef} in the composite material 100 is in a range of from a lower limit determined by the minimum L_{ef} as defined above, to an upper limit determined by multiplying the diameter of the reinforcement fibers 104 (Ø) by a factor of 1000. A safety factor, such as a value of 1.3, may be multiplied to the L_{ef} to account for any imperfection that may exist at the interface. For example, a composite material 100 having reinforcement fibers 104 with a diameter of 20 microns may have the L_{ef} in a range of from about 1 mm to about 20 mm, or from about 1 mm to about 26 mm. Similarly, a composite material 100 having reinforcement fibers 104 with a diameter of 7 microns may have the L_{ef} in a range of from about 0.35 mm to about 7 mm, or about 0.35 mm to about 9.1 mm.

### Bonding Performance

The bonding mechanism between the fiber-reinforced polymer composite 102 and the thermoplastic-based material 108 included in the composite material 100 of one or more embodiments may include the following. First, a bond produced by the diffusion of the melted polymer chain of TP resin from the thermoplastic-based material 108 into the molecular network of the polymer resin 106 included in the fiber-reinforced polymer composite 102, which occurs due to the molecular motion caused by heating of the TP resin. Second, the mechanical bonding established due to the presence of the fiber-bridging feature between the fiber-reinforced polymer composite 102 and the thermoplastic-based material 108.

The factors that affect the bonding strength between the fiber-reinforced polymer composite 102 and the thermoplastic-based material 108 may include, but are not limited to, the strength of the polymer resin 106 included in the fiber-reinforced polymer composite 102, the strength of the TP resin included in the thermoplastic-based material 108, the strength of the reinforcement fibers 104, adhesive strength between the polymer resin 106 and the reinforcement fibers 104, adhesive strength between the thermoplastic-based material 108 and the reinforcement fibers 104, and the adhesive strength between the polymer resin 106 included in the fiber-reinforced polymer composite 102 and the TP resin included in the thermoplastic-based material 108. The bonding strength may be affected by the residual stress within the composite material 100 resulting from the heat transfers during the bonding process. The bonding strength may be affected by process parameters for obtaining the fiber-bridging feature, such as the hardness of the material used in the mechanical abrader, such as a roller, and the speed and duration of polymer resin abrasion step. The removal step of the polymer resin 106 from the fiber-reinforced polymer composite 102 is described in the subsequent sections. The bonding strength may also be affected by the number of fiber ends per unit area, ρ_{surf},

The bond strength may also be affected by the thermomechanical properties of the polymer resin 106 and the TP resin included in the thermoplastic-based material 108. For example, a low glass transition temperature may promote removal of the polymer resin 106. The bond strength may be affected by the morphology of the bond surfaces.

### Method for Bonding Thermoplastic-Based Material to Fiber-Reinforced Polymer Composites via Fiber-Bridging

The present disclosure generally relates to a method for bonding a thermoplastic-based material to a fiber-reinforced polymer composite via fiber-bridging. The method may include removing a portion of a polymer resin 106 from a fiber-reinforced polymer composite 102 to expose a portion of a plurality of reinforcement fibers 104 of the fiber-reinforced polymer composite 102. The method may further include heating at least a portion of a thermoplastic-based material 108 to a bonding temperature, and contacting the heated portion of the thermoplastic-based material 108 to the exposed portion of the plurality of the reinforcement fibers 104, and embedding at least a portion of the exposed portion of the plurality of the reinforcement fibers 104 in the thermoplastic-based material 108.

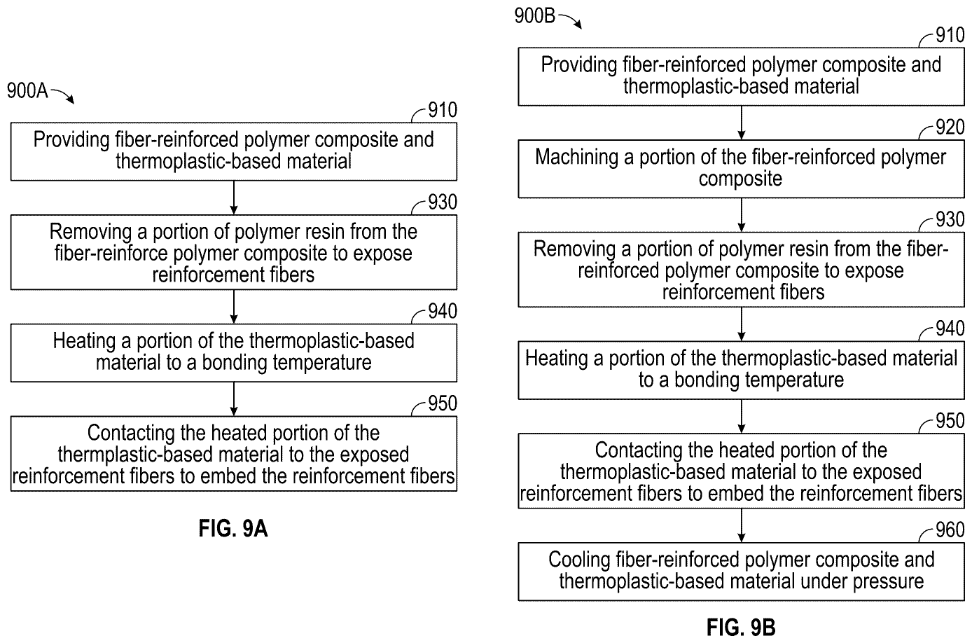

FIG. 9A is a flow diagram illustrating the method for bonding thermoplastic-based material to fiber-reinforced polymer composites via fiber-bridging of one or more embodiments. The method 900A includes providing fiber-reinforced polymer composite 102 including a plurality of reinforcement fibers 104 and a polymer resin 106, and a thermoplastic-based material 108 to be bonded together (step 910). In step 930, a portion of the polymer resin 106 from the fiber-reinforced polymer composite 102 is removed to expose a portion of the plurality of the reinforcement fibers 104 of the fiber-reinforced polymer composite 102. The exposed portion of the plurality of the reinforcement fibers 104 may be end portions of the plurality of the reinforcement fibers 104. In step 940, the thermoplastic-based material 108 is heated to a bonding temperature. In step 950, a heated portion of the thermoplastic-based material 108 is contacted with the exposed portion of the plurality of the reinforcement fibers 104 and a portion of the plurality of the reinforcement fibers 104 is embedded in the thermoplastic-based material 108.

FIG. 9B is a flow diagram illustrating the method for bonding a thermoplastic-based material 108 to a fiber-reinforced polymer composite 102 via fiber-bridging according to one or more embodiments. The method 900B of FIG. 9B includes the steps 910, 930, 940 and 950 as previously described for FIG. 9A, and further includes machining a portion of the fiber-reinforced polymer composite 102 (step 920). The machining step 920 may be conducted before the removal of polymer resin 106 (step 930).

In one or more embodiments, the method includes removing a portion of the polymer resin 106 from the fiber-reinforced polymer composite 102 to expose a portion of the plurality of the reinforcement fibers 104 (step 930). The removal of polymer resin 106 may be conducted by, for example, abrading the fiber-reinforced polymer composite 102, thermally decomposing a portion of the polymer resin 106, chemically decomposing a portion of the polymer resin 106 which may include the use of acids, peroxides or base, or combinations thereof. The removal process of the polymer resin 106 via thermal decomposition or chemical decomposition may require additional considerations to avoid unintentional damaging of fibers and removal of fiber coating (fiber sizing). Reducing the taper angle θ of the tapered portion 118 may reduce the amount of polymer resin 106 that needs to be removed to provide a sufficient length of the exposed portion of the reinforcement fibers 104. For example, removal of more polymer resin 106 may be required for a tapered portion 118 having θ of 90 degrees compared to a tapered portion 118 having θ close to 0 degrees, such as 5 degrees or less, or 1 degree or less.

In one or more embodiments, the removal of the portion of the polymer resin is conducted via abrasion including mechanical abrasion, such as by softly rubbing (low-abrasion treatment) the surface of the fiber-reinforced polymer composite 102 with an abrasion apparatus. The abrasion apparatus may include, but is not limited to, a rotating roller, orbital sander, and belt sander. The removal step frees up multiple reinforcing fiber ends from the polymer resin 106, which are then wetted by the heated thermoplastic-based material 108 and embedded in the thermoplastic-based material 108. The exposure of the reinforcement fiber ends provides a larger total contact surface with the thermoplastic material than without the contribution of the fibers.

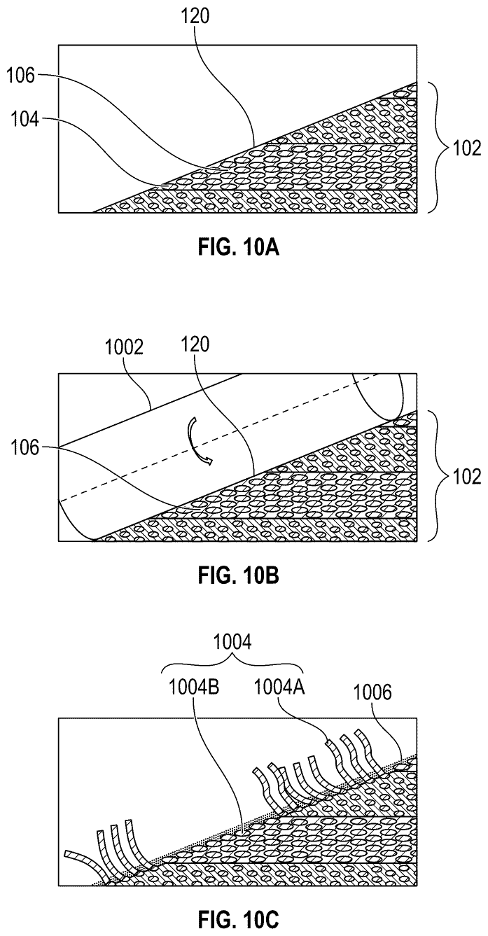

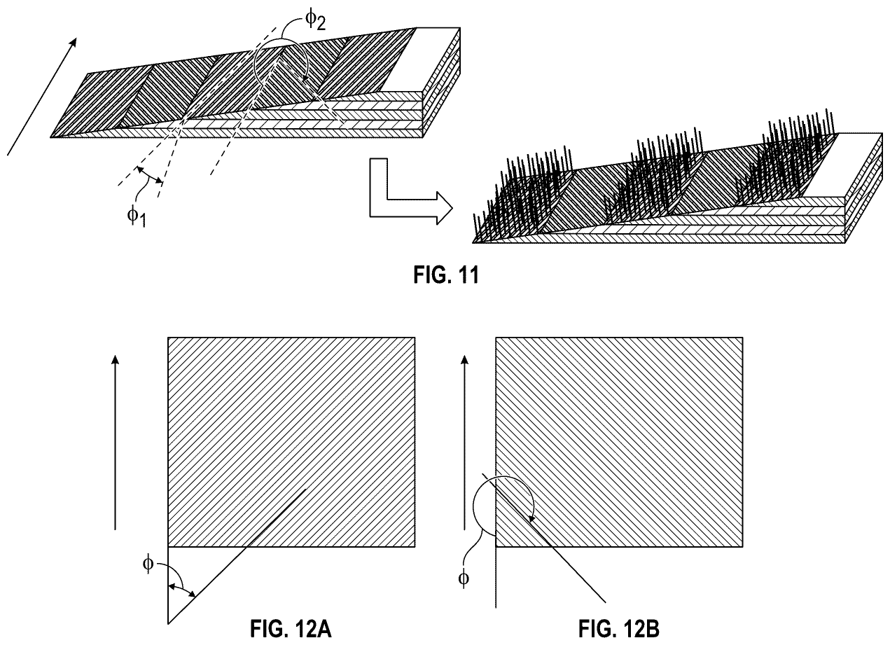

FIGS. 10A-10C show an exemplary step of removing a portion of the polymer resin 106 from the fiber-reinforced polymer composite 102 with an abrasion apparatus. FIG. 10A shows a fiber-reinforced polymer composite 102 including reinforcement fibers 104 and polymer resin 106. The fiber-reinforced polymer composite 102 of FIG. 10A has a multi-layered structure. As shown in FIG. 10B, a rotating roller 1002 is contacted on a bonding surface 120 of the fiber-reinforced polymer composite 102, and the friction generated by the rotating roller 1002 erodes the polymer resin 106 on and the vicinity of the bonding surface 120. As shown in FIG. 10C, the removal of the polymer resin 106 from the fiber-reinforced polymer composite 102 results in release of a portion of the reinforcement fibers 104 from the fiber-reinforced polymer composite 102 and forming of a free end portion 1004 (exposed portion 1004) of the reinforcement fibers 104. The eroded portion 1006 of the polymer resin 106 is shown in FIG. 10C. Depending on the ply angle of each ply and the direction of the roller rotation, the free end portion 1004 of each ply may have a different orientation angle with respect to a portion of the reinforcement fibers 104 embedded in the fiber-reinforced polymer composite 102. For example, the free end portion 1004A of FIG. 10C is oriented at a greater angle than the free end portion 1004B with respect to the portion of the reinforcement fibers 104 embedded in the fiber-reinforced polymer composite 102. A perspective view of a fiber-reinforced polymer composite 102 before and after the polymer resin removal process is shown in FIG. 11.

The bonding surface 120 of the fiber-reinforced polymer composite 102 may be a surface at the edge of the fiber-reinforced polymer composite 102, as shown in FIGS. 10A-10C. However, the bonding surface 120 is not limited to the surface at the edge, and may be any surface of the fiber-reinforced polymer composite 102 where it is possible to expose the reinforcement fibers 104 by removing a portion of the polymer resin 106. For example, the surfaces provided by the recessed portions of FIGS. 3-4 for pin welding can also be the bonding surface 120. In one or more embodiments, the bonding surface 120 may be located in the tapered portion 118 of the fiber-reinforced polymer composite 102.

In one or more embodiments, the abrasion apparatus, such as the rotating roller 1002, used in the polymer resin removal step is produced with a material having specific hardness and toughness in order to allow the erosion of the polymer resin 106 while minimizing or eliminating damage to the reinforcement fibers 104. The hardness of the abrasion apparatus may be greater than the hardness of the polymer resin 106 and less than the hardness of the plurality of the reinforcement fibers 104. In one or more embodiments, the material for the abrasion apparatus may have a hardness close to the hardness of the polymer resin 106, or less than twice the hardness of the polymer resin 106.

In one or more embodiments, Young's modulus may be used to approximate the hardness of the abrasion apparatus, the plurality of the reinforcement fibers 104, and the polymer resin 106. In one or more embodiments, the Young's modulus of the material used for the abrasion apparatus is from about 150% to about 600% of the Young's modulus of the polymer resin 106, such as in a range of from a lower limit of 150% to an upper limit selected from any one of 200%, 300%, 400%, 500% and 600%. If the Young's modulus of the material used for the abrasion apparatus is lower than the aforementioned range (i.e., the Young's modulus of the material for the abrasion apparatus is less than 150% of the Young's modulus of the polymer resin 106), excessive wear of the abrasion apparatus may occur, causing reduced resin removal efficiency and resulting in increased operational cost and processing time. In one or more embodiments, the Young's modulus of the material used for the abrasion apparatus is less than 50% of the Young's modulus of the reinforcement fibers 104 to minimize or prevent fiber damage during the resin removal process.

Exemplary materials that may be used to produce the abrasion apparatus, such as the rotating roller 1002, include, but are not limited to, TP resins as previously described such as polyolefins (polypropylene, polyethylene), engineering and specialty polymers including PA, POK, PVDF, PTFE, PPS, PEEK, PAEK, PEKK, and PEI, fiber-reinforced thermoplastic composite produced from at least one of the TP resins (e.g., 30% fiberglass/PEEK composite) and combinations thereof.

In one or more embodiments which the fiber-reinforced polymer composite 102 has oriented fibers, the removal of polymer resin 106 is conducted via abrasion at an angle φ with respect to a direction of at least a portion of the oriented reinforcement fibers in a range of about 0 degrees to about 90 degrees.

The abrasion angle φ is defined as follows and as shown in FIGS. 12A and 12B. When a specific ply of the fiber-reinforced polymer composite 102 with oriented fibers is abraded in the arrow direction as shown in FIG. 12A, φ is defined as the angle formed by the direction of abrasion (direction of the arrow) and the direction of the oriented reinforced fibers measured in a clock-wise direction from the direction of the direction of abrasion. Based on such definition, a ply with fiber directions perpendicular to the direction of abrasion has φ of 90 degrees, and a ply having a fiber direction as shown in FIG. 12B has φ greater than 90 degrees.

In one or more embodiments, the abrasion is conducted at an abrasion angle φ in a range of from a lower limit selected from any one of 0, 5, 10, 20, and 30 degrees to an upper limit selected from any one of 60, 70, 80 and 90 degrees, where any lower limit may be paired with any upper limit. In one or more embodiments, φ is 35 degrees. Removing the polymer resin 106 at an abrasion angle φ in the above range may provide exposed fiber ends that are substantially detached from the polymer resin 106, which would provide good bonding properties between the fiber-reinforced polymer composite 102 and thermoplastic-based material 108 when the exposed fibers are embedded in the thermoplastic-based material 108.

As an example, a fiber-reinforced polymer composite 102 having a configuration and abraded in the arrow direction as shown in FIG. 11 has plies having two different φ, φ₁ and φ₂, where φ₁ is less than 90 degrees and φ₂ is greater than 90 degrees.

While the embodiments shown in FIG. 11 have a multilayer configuration and includes plies with two abrasion direction φ₁ and φ₂, the abrasion may be conducted on a fiber-reinforced polymer composite 102 having a single-layer configuration. In one or more embodiments, the fiber-reinforced polymer composite 102 has plies having a plurality of fiber orientations, and accordingly, a plurality of abrasion directions.

The process parameters for abrasion step, such as abrasion speed (e.g., rotation speed of the rotating roller 1002) and duration may be optimized based on the requirements of each application. Completion of the abrasion step may be determined by visually inspecting the abraded surface and confirming the presence of sufficient exposed portion 1004 of the reinforcement fibers 104.

In one more embodiments, the abrasion is conducted in one direction or in multiple directions. For example, the abrasion may be conducted, targeting layers having a first ply angle, at an abrasion angle in a range of from 0 to 90 degrees with respect to the first ply angle, and additional abrasion is conducted, targeting layers having a second ply angle, at an abrasion angle in a range of from 0 to 90 degrees with respect to the second ply angle. Such abrasion process may increase the number of exposed fiber ends that are substantially detached from the polymer resin 106, further improving the bonding properties between the fiber-reinforced polymer composite 102 and thermoplastic-based material 108.

Referring back to FIGS. 9A-9B, in one or more embodiments, the method includes heating at least a portion of the thermoplastic-based material 108 to a bonding temperature (step 940). A bonding temperature is a temperature at which the thermoplastic-based material 108 becomes sufficiently flowable such that the heated thermoplastic-based material 108 can embed the exposed portion 1004 of the plurality of the reinforcement fibers 104 upon contact, with or without pressure. The bonding temperature may be the melting temperature of the thermoplastic-based material 108 or a temperature above the melting point. The bonding temperature may be the softening point of the thermoplastic-based material 108 or a temperature above the softening point. In one or more embodiments, the bonding temperature is in a range of from about 60 °C to about 500 °C, such as in a range of from a lower limit selected from any one of 60, 70, 80, 90, 100, 200 and 300 °C, to an upper limit selected from any one of 400, 450 and 500 °C, where any lower limit may be paired with any upper limit. However, the bonding temperature may be above or below the aforementioned ranges depending on the properties of the thermoplastic-based material 108.

In one or more embodiments, the method includes contacting the heated portion of the thermoplastic-based material 108 to the exposed portion 1004 of the plurality of the reinforcement fibers 104 of the fiber-reinforced polymer composite 102 to embed at least a portion of the exposed portion 1004 of the plurality of the reinforcement fibers 104 in the thermoplastic-based material 108. (step 950).

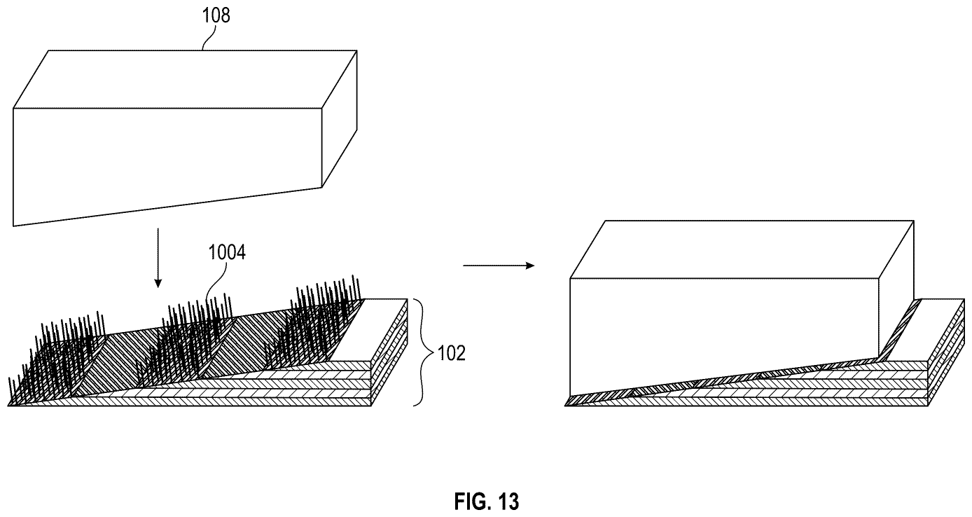

FIG. 13 shows the step of contacting the heated portion of the thermoplastic-based material 108 to the portion of the fiber-reinforced polymer composite 102 from which the polymer resin 106 is removed and the exposed portion 1004 of the plurality of reinforcement fibers 104 are present. The heated portion of the thermoplastic-based material 108 is at a bonding temperature and the TP resin of the thermoplastic-based material 108 flows to wet the exposed portion 1004 upon contact and the exposed portion 1004 become embedded in the thermoplastic-based material 108.

The contacting may be conducted at a pressure in a range of from about 0.5 MPa to about 5 MPa, and a duration in a range of from about 30 seconds to about 20 minutes. The pressure and the duration of the contacting step may be above or below the aforementioned ranges, and may be appropriately determined based on the requirements of each application.

The heating and contacting steps may be conducted sequentially or simultaneously. The heating and contacting may be conducted using the methods and equipment available in the art. Exemplary methods may include, but are not limited to, electrofusion welding, induction welding, friction welding, rotary friction welding, and combinations thereof.

In one or more embodiments, the equipment used in the removing process of the polymer resin 106 is different from the equipment used for the heating and contacting steps. In one or more embodiments, the same equipment is used to conduct the removing, heating and contacting steps such that the polymer resin 106 can be eroded to produce exposed portion 1004 of the plurality of reinforcement fibers 104, the exposed portion 1004 can immediately be wet out with the heated thermoplastic-based material 108 to be embedded.

In one or more embodiments, in case the fiber-reinforced polymer composite 102 has a multilayer structure, the contacting and embedding result in a plurality of reinforcement fibers 104 from at least one layer, or at least two layers, of the fiber-reinforced polymer composite plies to be embedded in the thermoplastic-based material 108. In one or more embodiments, the contacting and embedding result in a plurality of reinforcement fibers 104 from all layers of the fiber-reinforced polymer composite plies to be embedded in the thermoplastic-based material 108.

In one or more embodiments, the method includes machining a portion of the fiber-reinforced polymer composite 102 to produce a tapered portion 118 (step 920 of FIG. 9B). As previously described, a tapered portion 118 may provide a larger surface area for the bonding of the fiber-reinforced polymer composite 102 and the thermoplastic-based material 108, and may provide a higher number of exposed fibers during the removal of polymer resin 106. Furthermore, in case of a fiber-reinforced polymer composite 102 having a multilayer configuration, the machining may expose the surfaces of all layers of the fiber-reinforced polymer composite 102, further contributing to the adhesive strength.

In one or more embodiments, in case of fiber-reinforced polymer composite 102 having a multilayer structure, the machining (step 920) comprises machining a portion of all layers of the at least two layers of the fiber-reinforced polymer composite plies. Machining all layers of the fiber-reinforced polymer composite may result in the exposure of all layers, which would allow removal of polymer resin 106 and exposure of reinforcement fiber ends from all layers to such that the fiber-bridging features can be obtained from all layers of the fiber-reinforced polymer composite 102.

The machining may be conducted at any portion of the fiber-reinforced polymer composite 102. For example, as previously described, the machining may be conducted away from the edges of the composite, such as at the recessed portion 112 for the pin weld as shown in FIGS. 3 and 4. In one or more embodiments, the machining may be conducted at the edge portion of the fiber-reinforced polymer composite 102.

In one or more embodiments, the machining is conducted to produce a tapered portion 118 having a taper angle θ of greater than 0 degrees and about 90 degrees or less. In one or more embodiments, the taper angle θ is in a range of from a lower limit selected from any one of 0.01, 0.1, 0.5, 1, 2, 2.5 3, 4, 5, 10, 20, 30, 40 and 45 degrees, to an upper limit selected from any one of 10, 20, 30, 40, 45, 50, 60, 70, 80 and 90 degrees, where any lower limit may be paired with any mathematically-compatible upper limit.

Machining of the fiber-reinforced polymer composite 102 may be conducted by the methods available in the art. Equipment that may be used for machining may include, but are not limited to, saws such as circular saws, tile saws, and band saws, surface grinders, water-jet cutters, laser cutters, sanders, routers, milling machines, and drills. Any of the aforementioned equipment may be manual or automated such as with Computer Numerical Control (CNC). The machined surface may be flat, contoured, or may have a random topography.

In one or more embodiments, machining step is conducted prior to the polymer resin 106 removing, heating and contacting steps.

In one or more embodiments, the method includes cooling the fiber-reinforced polymer composite 102 and the thermoplastic-based material 108 under pressure in order to firmly embed the exposed portion of the plurality of the reinforcement fibers 104 in the thermoplastic-based material 108. (step 960 of FIG. 9B). In one or more embodiments, the cooling step under pressure may be conducted until the temperature of the fiber-reinforced polymer composite 102 reaches an ambient temperature, such as a temperature in a range of from about 20 °C to about 30 °C, or 23 °C, or lower than the ambient temperature. In one or more embodiments, the cooling step under pressure may be conducted until the temperature of the fiber-reinforced polymer composite 102 reaches about 5, 10, 20, 30, 40, 50, 60, 70, 80, 90 or 100 °C below the softening or melting point of the thermoplastic-based material 108, or lower. For example, the cooling step under pressure may be conducted at a temperature of 85 °C for a duration in a range of from 15 minutes to 60 minutes, or more. In one or more embodiments, the cooling under pressure may be conducted at a service temperature in which the composite material 100 is subjected to, which may be higher or lower than the ambient temperature.

In one or more embodiments, the method further includes, as an optional step, a fiber reorientation step to reorient the direction of at least a portion of the exposed portion 1004 of the plurality of reinforcement fibers 104. The fiber reorientation step may be conducted after the removal step of the polymer resin 106. The fiber reorientation step may be conducted by using an apparatus which is capable of targeting specific portions of the exposed portion (free end portion) 1004 of the reinforcement fibers 104, and reorient the direction of the free end portion 1004 by providing sufficient friction to the exposed portion 1004 without damaging the reinforcement fibers 104. For example, FIG. 10C shows reinforcement fibers 104 having a free end portion 1004 after the removal step of polymer resin 106, includes a free end portion 1004A oriented at a greater angle than a free end portion 1004B with respect to the portion of the reinforcement fibers 104 embedded in the fiber-reinforced polymer composite 102. In such a case, the fiber reorientation step may be conducted at the section having the free end portion 1004B by applying friction to the free end portion 1004B with an apparatus, such as a rotating roller 1002, such that the direction of the free end portion 1004B may be reoriented to be directed at a greater angle with respect to the respect to the portion of the reinforcement fibers 104 embedded in the fiber-reinforced polymer composite 102. Such process may provide a free end portion 1004 of the reinforcement fibers 104 that can be additionally embedded in the thermoplastic-based material 108 to further improve the bonding properties between the fiber-reinforced polymer composite 102 and the thermoplastic-based material 108.

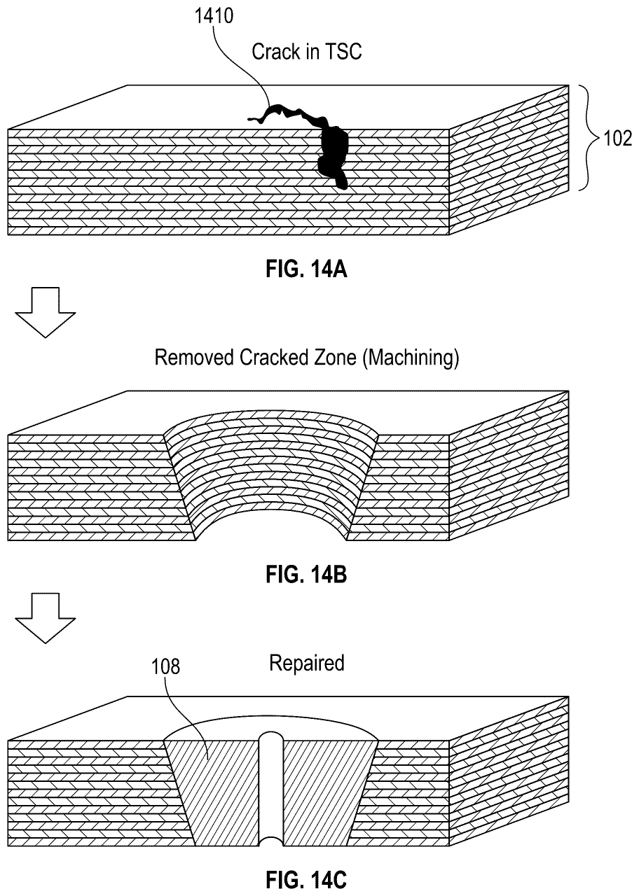

The method of one or more embodiments may be used to repair damaged or cracked areas of the fiber-reinforced polymer composite 102 temporarily or permanently. In one or more embodiments, the method further includes, as an optional step, removing a damaged area from the fiber-reinforced polymer composite 102. The fiber-reinforced polymer composite 102 repaired by the method of one or more embodiments is shown in FIGS. 14A-14C. FIG. 14A illustrates a fiber-reinforced polymer composite 102 with a damaged area 1410, where the damage may be in a form of cracks. As shown in FIG. 14B, the damaged area 1410 is removed using methods available in the art, such as machining. As shown in FIG. 14C, a thermoplastic-based material 108 is then bonded to the fiber-reinforced polymer composite 102 at the area where the damaged area 1410 was removed form. The bonding is conducted by the method of one or more embodiments to produce a composite material 100 of one or more embodiments having the fiber-bridging feature, thereby repairing the damaged fiber-reinforced polymer composite 102 and preventing further propagation of the damage. FIGS. 14A-14C show an exemplary repairing process with the use of a conical thermoplastic-based material 108. However, specific configuration and geometry of the repaired area, and the type and shape of the thermoplastic-based material 108 may be determined based on the requirements of each application.

The bonding method of the present disclosure may provide an improved bonding speed because the method does not require any chemical reaction, such as curing of a thermoset adhesive, and only requires cooling of the TP weld, which may be substantially shorter than bonding agent that requires chemical reaction. Therefore, the time required to achieve full strength is substantially reduced.

The bonding method of the present disclosure may also provide a shear strength comparable or superior to common adhesive bond, such as Araldite® A900. As demonstrated in the examples provided below, the resulting shear strain of the composite material produced by the method of the present disclosure may be several times higher than that of TSC/TP thermal welding without the fiber-bridging feature.

Furthermore, the method may be fully automated and does not require numerous or complex steps, such as mixing of a hardener and a polymer as in the case of a two-part thermoset adhesive.

The composite material and the bonding method of the present disclosure may also provide flexibility in bond design. Conventional bonding techniques between a TP and a TSC does not include the fiber-bridging feature and such configuration limits the bond surface to be parallel to the TSC plies. The bonding method of the present disclosure relies on fiber ends having an angle greater than 0° with respect to the TSC plies. Such configuration may allow new bonding designs as illustrated above.

### EXAMPLES

The following examples are provided to illustrate embodiments of the present disclosure. The Examples are not intended to limit the scope of one or more embodiments of the present invention, and they should not be so interpreted.

### Example 1

Exemplary composite materials were prepared by bonding a glass-reinforced (GR) epoxy (GRE) cylinder with a PEEK cylinder using the bonding method provided in the present disclosure. 5 samples were prepared. Samples 1 and 2 were prepared from GRE cylinder having 80 mm inner diameter in “box” and “pin” configurations, respectively. Samples 3 and 4 were prepared from GRE cylinder having 8 inch inner diameter in box and pin configurations, respectively. Sample 5 was prepared from GRE cylinder having 80 mm inner diameter and PEEK cylinder in pin configuration.

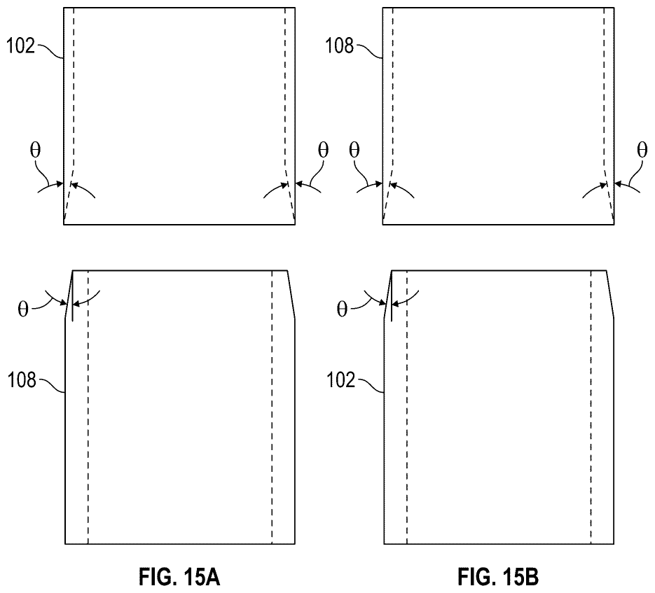

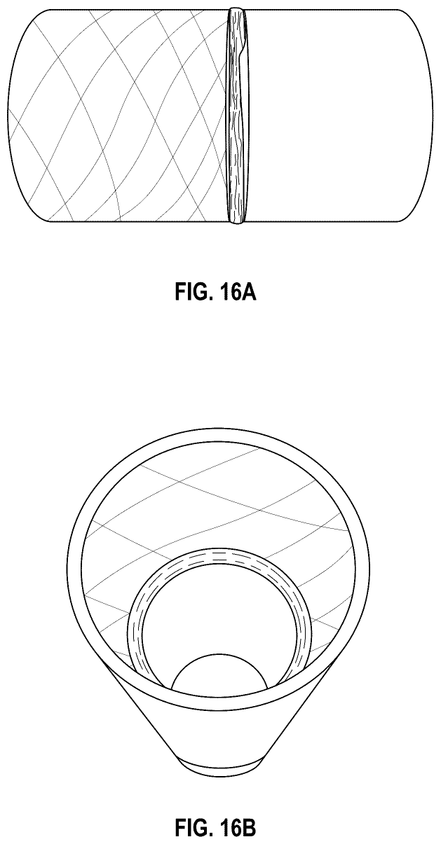

A box configuration, which is shown in the schematic diagram of FIG. 15A, refers to a configuration in which the inner surface of the fiber-reinforced composite material 102 (e.g., GRE cylinder of EXAMPLE 1) and the outer surface of the thermoplastic-based material 108 (e.g., PEEK cylinder of EXAMPLE 1) are tapered at an angle θ such that the inner surface of the fiber-reinforced composite material 102 is bonded to the outer surface of the thermoplastic-based material 108 when joined.

A pin configuration, shown in the schematic diagram of FIG. 15B, refers to a configuration in which the outer surface of the fiber-reinforced composite material 102 (e.g., GRE cylinder of EXAMPLE 1) and the inner surface of the thermoplastic-based material 108 (e.g., PEEK cylinder of EXAMPLE 1) are tapered at an angle θ such that the outer surface of the fiber-reinforced composite material 102 is bonded to the inner surface of the thermoplastic-based material 108 when joined.

Appropriate surfaces of each of the GRE cylinder and the PEEK cylinder were machined with a manual shaver to obtain the box and pin configurations. The machined ends of the GRE and PEEK cylinders had a tapered edge having an angle θ of 5 degrees. The machined surface of the GRE cylinder was then “rubbed” or abraded with a rotating cylinder made with an orbital sander to expose the fiberglass of the GRE cylinder.

The machined surface of the PEEK cylinder was heated to a temperature between 420-440 °C for a few seconds and slid into the GRE cylinder such that the portion of GRE cylinder with exposed fiber is in contact with the machined and heated surface of the PEEK cylinder to create a conically-bonded joint. A pressure of 2 MPa was applied to the PEEK cylinder such that the heated surface of the PEEK cylinder sufficiently adheres to the surface of the GRE cylinder, and the exposed fiberglass becomes embedded in the PEEK resin. An example of the produced composite material of the GR epoxy and PEEK cylinders bonded with fiber-bridging in the box configuration is shown in FIGS. 16A-16B.

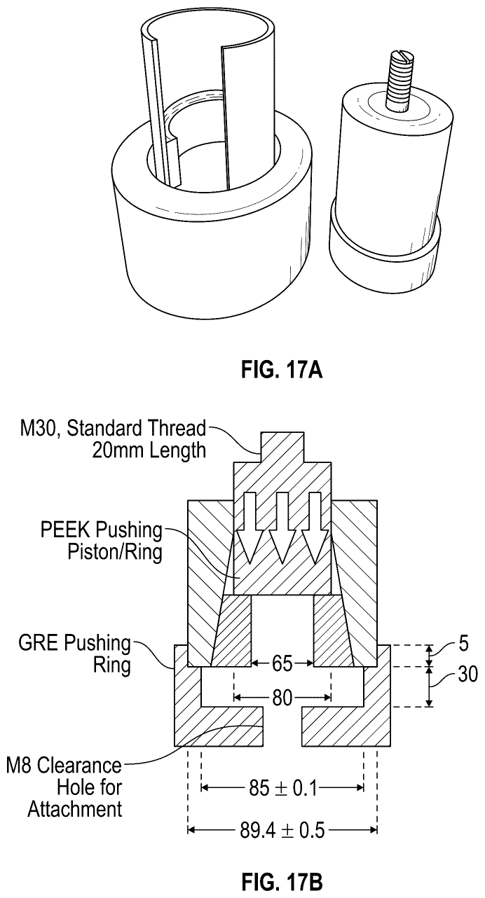

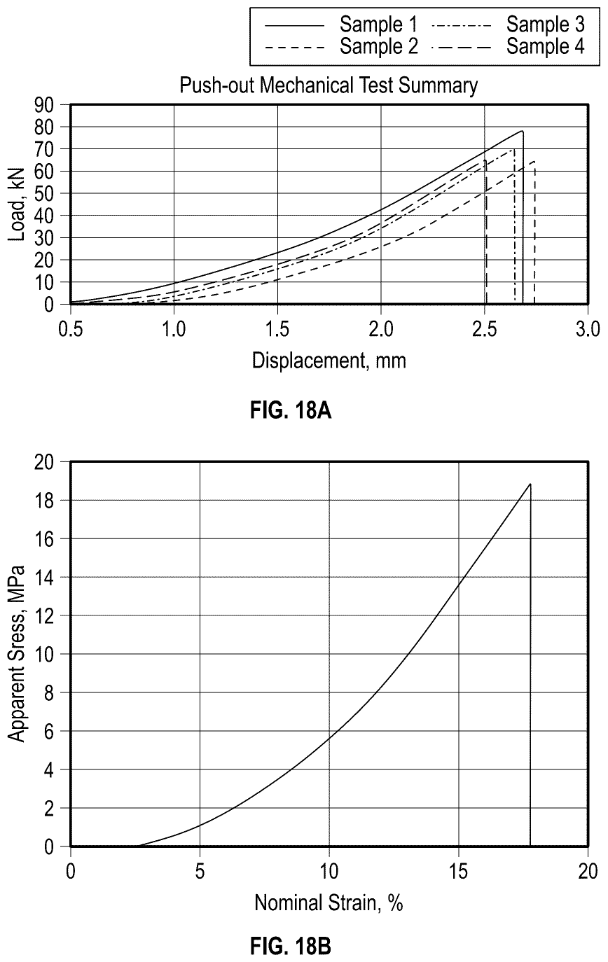

Ends of the samples 1-5 of EXAMPLE 1 containing the bonded joint were then cut such that the samples have a nominal length of 100 mm, and the samples were subjected to push-out testing. The edge surfaces of the samples were cleaned prior to the push-out testing using an end mill to ensure good contact with the testing rig during the testing. A push-out testing rig (shown in FIG. 17A) was mounted on a tensile machine and the sample was placed in the rig such that the top and bottom edges of the sample was in contact with the metallic support (“pushing ring”) and displacement elements (“pushing piston/ring”) of the testing rig, as illustrated in FIG. 17B. Tests on 80 mm diameter specimens (Samples 1 and, 2 and 5) were carried out using a Shimadzu 100 kN AG-X plus universal test machine (J0051). Tests on 8-inch diameter specimens (Samples 3 and 4) were carried out using an Instron 600DX universal test machine (J0044). The push-out testing was conducted at a cross-head speed of 1 mm/s until the failure of the bonded joint occurred. The failure was said to have occurred when the applied load reduced to below 70% of the maximum applied load value. Nominal strain was calculated as the crosshead displacement divided by the initial joint length. Load vs. displacement graphs of samples 1-4 obtained from the push-out test are shown in FIG. 18A.

After testing, the length of the joint was measured from the two fracture surfaces. The circumference of the joint was calculated from the nominal mean diameter of the specimens at the center of the joint. Apparent stress was then calculated by dividing the load by the joint surface area. As an example, an apparent stress vs. nominal strain % graph of sample 5 calculated form the results of the push-out test is shown in FIG. 18B.

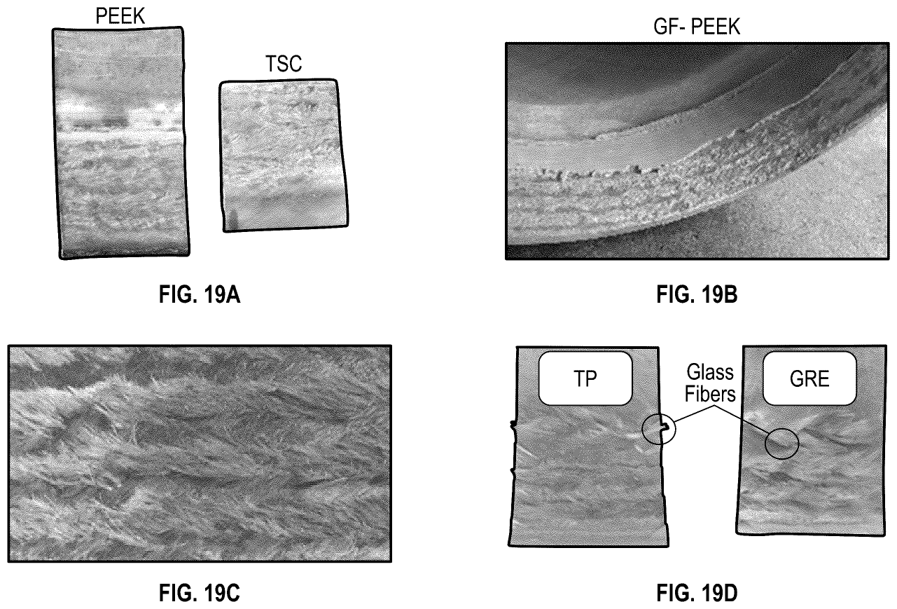

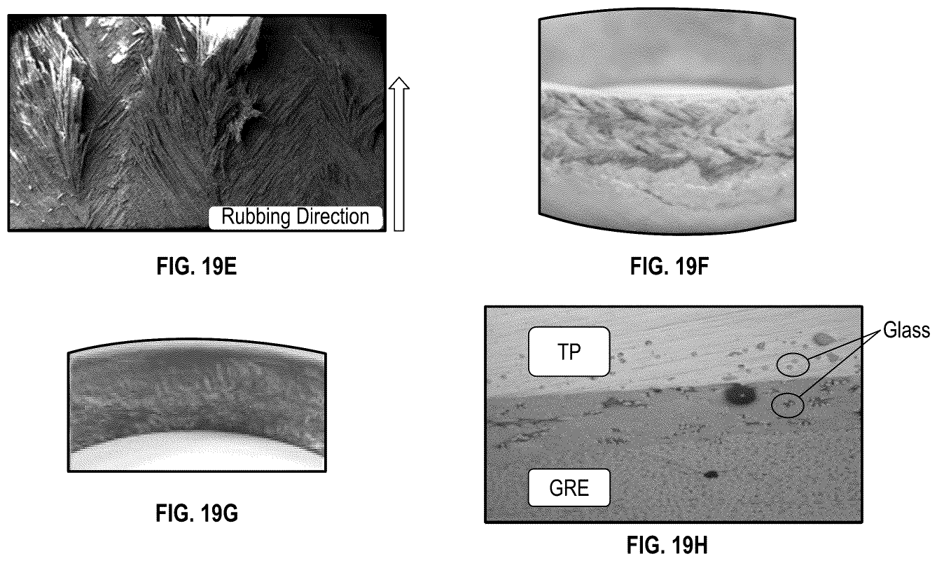

Debonded surfaces of the GR epoxy and PEEK cylinders of EXAMPLE 1 were then visually observed. FIGS. 19A-19G are images of the fractured surfaces of the GR epoxy and PEEK cylinders subjected to the push-out testing. FIGS. 19A-19E shows the fractured surfaces of the samples in box configuration, while FIGS. 19F and 19G shows the fractured surfaces of the GRE and PEEK cylinders bonded in the pin configuration. As seen in FIGS. 19A-19G, a portion of the fiberglass from GR epoxy cylinder remain adhered on the PEEK cylinder, indicating that the fiberglass was wetted by PEEK, creating the fiber-bridging, and fiber fracture occurred during the push-out test. FIG. 19H, which is a micrograph of the cross section of the GR epoxy/PEEK cylinder bonded joint, shows embedded glass fiber of the GR epoxy in PEEK, further confirming the presence of the fiber-bridging feature. FIGS. 19B-19E also shows the effect of rubbing process indicated by the direction of the exposed fiber ends.

### Example 2

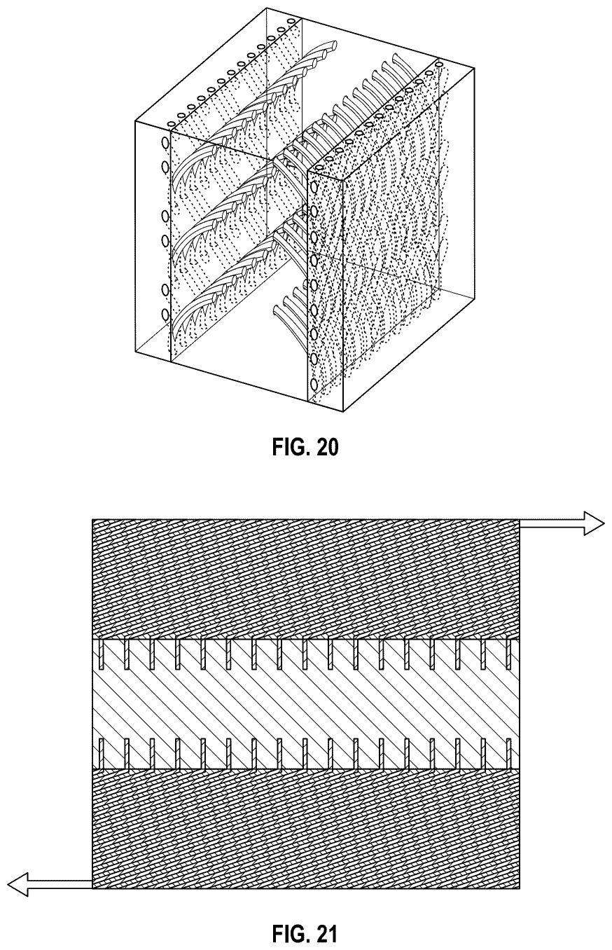

A numerical model of a composite material including a fiber-reinforced thermoset polymer composite (TSC) and PPS thermoplastic polymer (PPS-TP) was developed using a finite element method. FIG. 20 shows a numerical model configuration of EXAMPLE 3. EXAMPLE 3 contained two TSC surface layers with a thickness of 0.2 mm each, and a PPS TP interlayer with a thickness of 1 mm located between the TSC surface layers. The overall dimensions of the model was 1.65 mm length, 1.65 mm width and 1.4 mm thickness. EXAMPLE 3 further contained 36 glass fiber ends bonded to the TSC on one end and embedded in the PPS interlayer on the other end to simulate the fiber-bridging feature. The total cross sectional area of the fiber ends was 2.5% based on the total surface area of the GSC-TP interface. The length of the embedded portion of the glass fiber in PPS was set at 0.3 mm. The material properties of TSC, PPS-TP, and the interfacial mechanical properties between the TSC and PPS-TP, TSC and glass fiber (GF), and PPS-TP and GF used in the model are provided in Tables 1 and 2. “CZM” in Table 2 indicates that the contact and debonding were modeled using Cohesive Zone Model elements.

TABLE 1

| | | Young's | | |
|---|---|---|---|---|
| | | modulus | Yield | |
| | | (MPa) | (MPa) | Reference |
| Glass fiber | Elastic Isotropic | 69,000 | 2250 | Wikipedia |
| ECR | | | | |
| PPS Toraylina | Elastic-plastic | 3,400 | 85 | Toray datasheet |
| A900 | Isotropic | | | |
| TSC | Elastic | Stiffness | NA | Digimat model |
| | Anisotropic | Matrix | | |

TABLE 2

| | | Max. normal | Max. | Crack | Crack | |
|---|---|---|---|---|---|---|
| | | stress | tangential | Failure | Failure | |
| | | (MPa) | (MPa) | Energy 1 | Energy 2 | Damping (s) |
| GF - TSC | Bonded | NA | NA | NA | NA | NA |
| GF - PPS-TP | CZM | 15 | 10 | 117000 | 75000 | 0.03 |
| TSC - PPS-TP | CZM | 8 | 4 | 6000 | 3000 | 0.03 |
| TSC - Araldite 900 | CZM | 15 | 10 | 117000 | 75000 | 0.03 |

The model of EXAMPLE 2 was subjected to an opposing and proportional out-of-plane displacement at the top and bottom edges of the TSC surface layers to simulate a material under pure shearing mode. A schematic of the simulated displacement applied to the model is shown in FIG. 21. The applied displacement was increased until a failure conditions were met based on the entered material and interfacial properties. The failure conditions were considered to have met when any portion of the internal stress reached either the yield stress of the fiber or the thermoplastic polymer. The bonding mode of EXAMPLE 2 was a mix of TSC-PEEK-TP cohesive bond and mechanical locking due to the embedded fibers in the PEEK-TP.

### Comparative Example 1

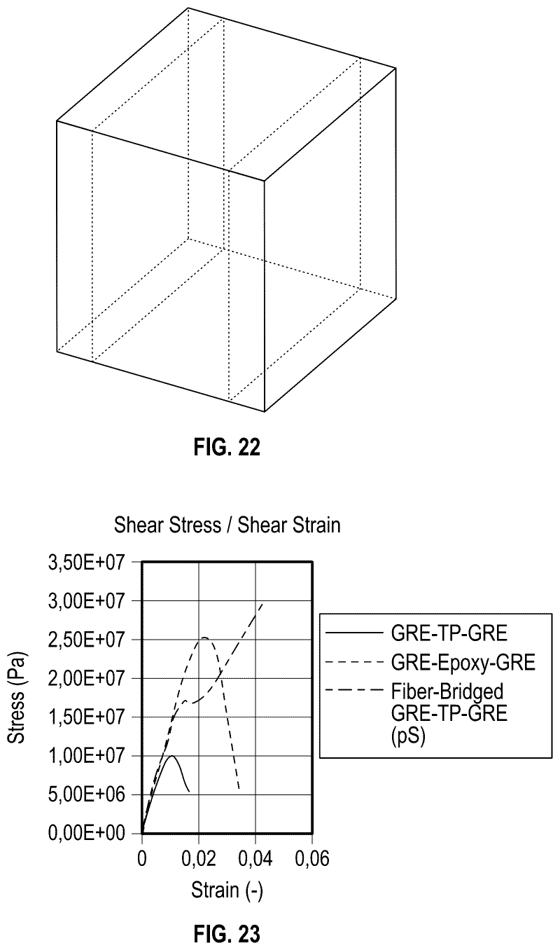

A numerical model of a composite material including two surface TSC and a PPS thermoplastic polymer (PPS-TP) interlayer, and without fiber-bridging was developed using a finite element method. FIG. 22 shows a numerical model configuration of COMPARATIVE EXAMPLE 1. The overall dimensions of COMPARATIVE EXAMPLE 1 and the applied displacement conditions were identical to those of EXAMPLE 2. The material properties of TSC for EXAMPLE 2 were used for TSC of COMPARATIVE EXAMPLE 1. Materials properties of PPS-TP and TSC/PPS-TP interfacial properties are shown in Tables 1 and 2. The bonding mode of COMPARATIVE EXAMPLE 1 was purely cohesive.

### Comparative Example 2

A numerical model was developed and the simulation was conducted in the same manner as COMPARATIVE EXAMPLE 1 except that the PPS-TP was replaced by an epoxy glue interlayer. The properties of the epoxy glue interlayer was based on Araldite® A900 epoxy adhesive. Materials properties of the epoxy adhesive and TSC/epoxy interfacial properties are shown in Table 2. The bonding mode of COMPARATIVE EXAMPLE 2 was purely cohesive.

### Reference Example 1

An experimental yield strength of a composite material including two TSC face layers and a PPS-TP interlayer was obtained from NIC technical report. The material of REFERENCE EXAMPLE 1 does not include the fiber-bridging feature and the failure was cohesive only.

### Reference Example 2

An experimental yield strength of a composite material including two TSC face layers and Easy-Fit epoxy adhesive interlayer was obtained from NIC technical report. The material of REFERENCE EXAMPLE 2 does not include the fiber-bridging feature.

### Simulation Test Results

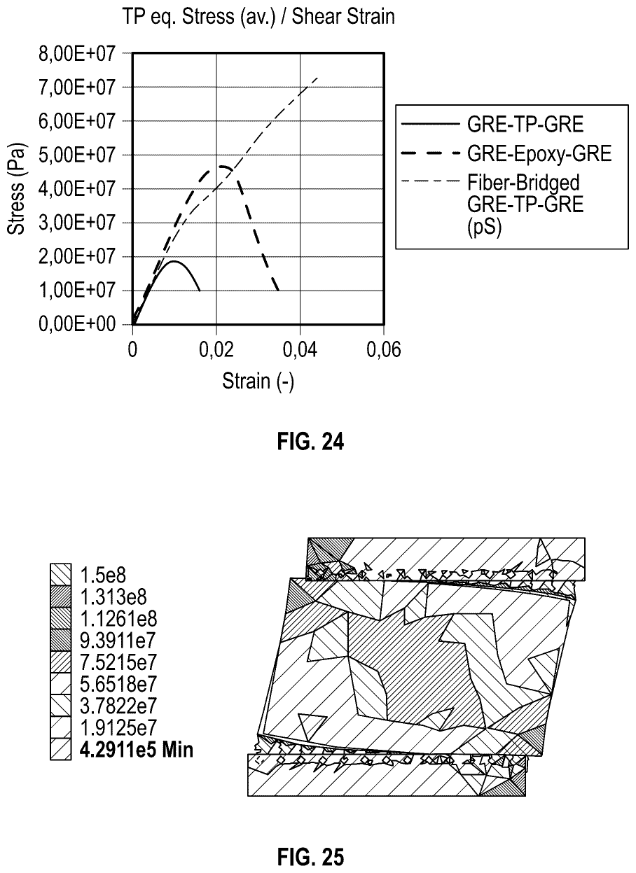

Ultimate failure/yield strength σᵤ and ultimate strain at break & obtained from the simulation conducted on the models of EXAMPLE 2, and COMPARATIVE EXAMPLES 1-2 are provided in Table 3. The ultimate failure strength and ultimate strain at break obtained from the push-out test of EXAMPLE 2, and those of REFERENCE EXAMPLE 1-2 are also provided in Table 3. In addition, shear stress/shear strain curves and matrix average equivalent stress/shear strain curves of the simulations of EXAMPLE 2 and COMPARATIVE EXAMPLES 1-2 are shown in FIGS. 23 and 24, respectively.

TABLE 3

| | | | Ultimate | |
|---|---|---|---|---|
| | | Ultimate | strain | |
| | | failure/Yield | at | |
| | | strength | break | |
| | Bond type | (MPa) | (—) | Remarks |
| EXAMPLE 1 | PEEK-TSC fiber- | 18 | NA | Push out test. Fiber-bridging |
| | bridging Cohesive- | | | only present on 50% of |
| | Interlocking | | | bonding surface |
| EXAMPLE 2 | PPS-TSC fiber- | 30.5 | 0.046 | Ansys analysis Unfilled PPS - |
| | bridging Cohesive- | | | fiber bridging |
| | Interlocking | | | |
| REFERENCE | TSC-PEEK-TSC | 8-13 | NA | NIC technical report |
| EXAMPLE 1 | Cohesive only | | | Unfilled PEEK |
| COMPARATIVE | TSC- TP -TSC | 19.8 | 0.015 | Ansys analysis Unfilled PPS |
| EXAMPLE 1 | Cohesive only | | | |
| REFERENCE | TSC - epoxy - | 14-16 | NA | NIC technical report |
| EXAMPLE 2 | TSC Cohesive | | | |
| COMPARATIVE | TSC - Araldite - | 23.6 | 0.035 | Ansys analysis Araldite |
| EXAMPLE 2 | TSC Cohesive | | | A900 |

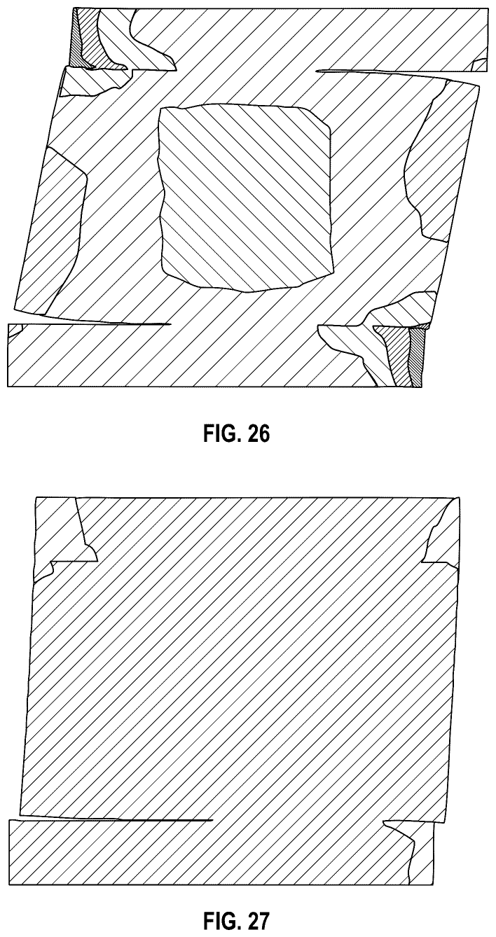

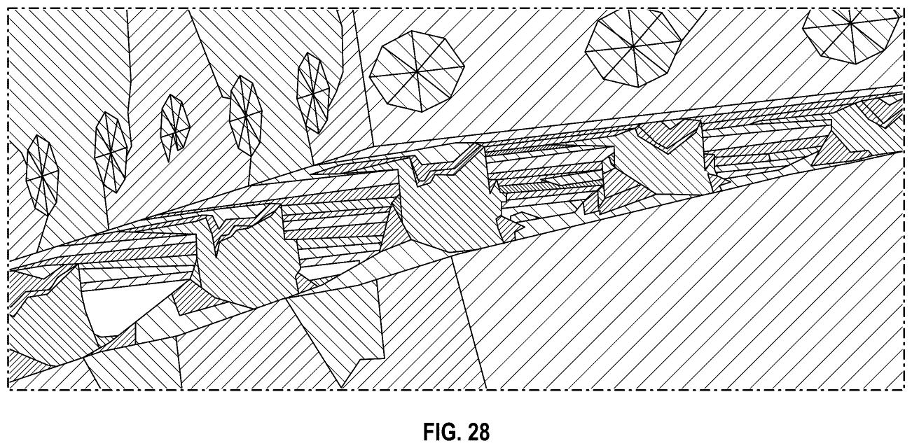

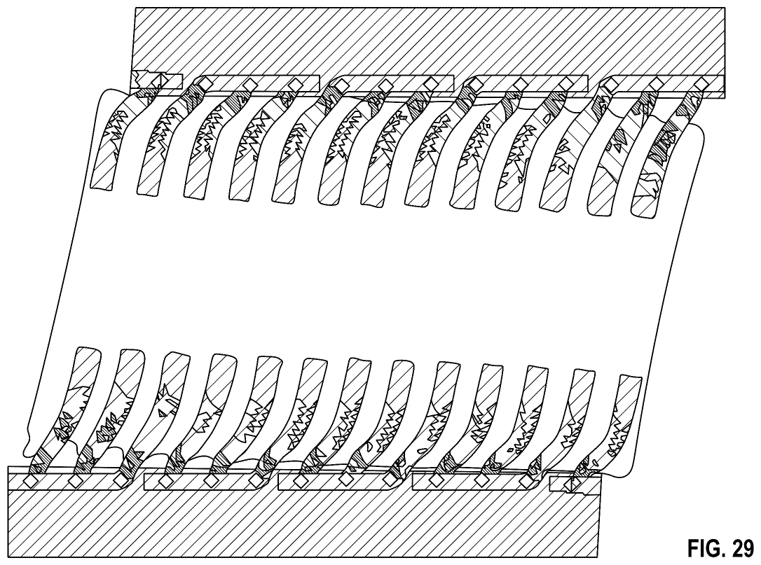

Stress concentration contour lines within EXAMPLE 2 and COMPARATIVE EXAMPLE 1-2 at failure are shown in FIGS. 25-27, respectively. The values shown in the scale in FIG. 25 correspond to the stress concentration in each regions defined by the contour lines, which are also applicable for FIGS. 26-29. Magnified views of the stress concentration contour lines of the fibers within EXAMPLE 2 and depending of glass fiber from PPS are shown in FIGS. 28 and 29. FIGS. 25 and 28-29 show that much higher stress concentrations are present within the fibers bridging of EXAMPLE 2, compared to the maximum concentrations present within the models of COMPARATIVE EXAMPLES 1 and 2. Furthermore, plastic deformation of the TP near the embedded fibers can also be observed in FIG. 28 (deformation scale factor of 3) and FIG. 29 (deformation scale factor of 5).

Table 3 and FIGS. 23-24 show that the ultimate failure strength σᵤ and ultimate strain at break εᵤ of COMPARATIVE EXAMPLE 2 was substantially higher than those of COMPARATIVE EXAMPLE 1, indicating a higher bonding strength of the epoxy to the TSC than the bonding strength of PEEK-TP to the TSC.

Furthermore, the ultimate failure strength σᵤ of EXAMPLE 1 was approximately 20% greater than that of COMPARATIVE EXAMPLE 2 and the ultimate strain at break εᵤ of EXAMPLE 2 was at least 25% greater than that of COMPARATIVE EXAMPLE 2, which had a substantially higher properties than COMPARATIVE EXAMPLE 1. In addition, the average equivalent stress of EXAMPLE 1 was approximately 73 MPa while that of COMPARATIVE EXAMPLE 2 was approximately 42 MPa. The results also show that composite material of EXAMPLE 1 can absorb up to twice the fracture energy absorbed by the bonded joint of TSC and epoxy adhesive of COMPARATIVE EXAMPLE 2.

The above test results show that the fiber-bridging feature of EXAMPLE 1 provides substantial improvement of the bonding properties between the TSC and TP even though the total cross sectional area of the fiber ends in the simulation was limited to 2.5% of the total bonding area. The improved bonding properties was obtained as result of fiber ends allowing the transfer of applied load to the thermoplastic matrix, and reducing the amount of load at the interface. Based on the above results, A TP having substantially high shear strength and creep resistance may be selected as a suitable material of the present composite material to accommodate for the increase stress due to the transfer of applied load by the fibers.

### Comparison of Experimental and Simulation Test Results

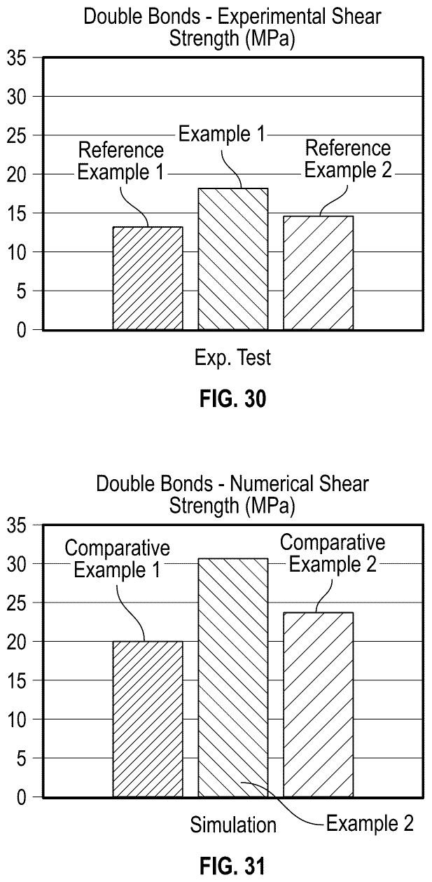

The simulation test results obtained from EXAMPLE 2 and COMPARATIVE EXAMPLES 1-2 were compared with the test results of EXAMPLE 1 and REFERENCE EXAMPLES 1-2. Experimental and computed shear strength of the above examples are shown in FIGS. 30-31 and the yield strength and ultimate strain at beak are shown in Table 3.

The results show that the simulation generally show good qualitative representation of the experimental results of the same material. The actual shear strength values of the experimental results were substantially lower than that of simulated values. The discrepancy between the experimental and simulated results may be attributed to the differences in process-induced stresses in TSC and TP, which are not accounted for in the simulations, geometrical characteristics and their effect on the thermal shrinkage at the interface (e.g. physical samples had round geometries, simulations were performed on flat representative volumes), sensitivity to process parameters, and the difference in fiber-end densities and distribution uniformity. Specifically, the fibers in the simulation may have a higher density and more uniform fiber distribution than those in experiments, where some amount of fiber-bridging was effective only on half the contact surface due to taper angle on TSC and pertaining to the method used to weld TSC and TP.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke means-plus-function for any limitations of any of the claims herein, except for those in which the claim expressly uses the words ‘means for’ together with an associated function.

What is claimed is:

1. A composite material, comprising:
a fiber-reinforced polymer composite comprising:
a polymer resin comprising at least one selected from the group consisting of a cured thermoset resin and a thermoplastic resin, and
a plurality of reinforcement fibers partially embedded in the polymer resin; and
a thermoplastic-based material,
wherein:
at least a portion of a fiber-reinforced polymer composite surface is in contact with at least a portion of a thermoplastic-based material surface,
an end portion of at least a portion of the plurality of the reinforcement fibers comprised in the fiber-reinforced polymer composite is embedded in the thermoplastic-based material, and
a portion of the plurality of reinforcement fibers excluding the end portion embedded in the thermoplastic-based material is embedded in the polymer resin of the fiber-reinforced polymer composite.

2. The composite material of claim 1, wherein the polymer resin comprises a cured thermoset polymer resin.

3. The composite material of claim 1, wherein the polymer resin comprises a thermoplastic polymer resin.

4. The composite material of claim 1, wherein the thermoplastic-based material comprises a thermoplastic polymer resin.

5. The composite material of claim 4, wherein the thermoplastic-based material further comprises a plurality of reinforcement fibers that is separate from the plurality of reinforcement fibers comprised in the fiber-reinforced polymer composite.

6. The composite material of claim 1, wherein the plurality of the reinforcement fibers in the fiber-reinforced polymer composite comprises continuous fibers.

7. The composite material of claim 1, wherein the plurality of the reinforcement fibers in the fiber-reinforced polymer composite comprises substantially oriented fibers.

8. The composite material of claim 1, wherein the fiber-reinforced polymer composite has a tapered portion having a taper angle of greater than 0 degree and 90 degrees or less.

9. The composite material of claim 1, wherein the end portion of the at least a portion of the plurality of the reinforcement fibers is oriented in a different direction with respect to the portion of reinforcement fibers embedded in the polymer resin of the fiber-reinforced polymer composite.

10. The composite material of claim 1, wherein:
the fiber-reinforced polymer composite comprises at least two layers of fiber-reinforced polymer composite plies,
each fiber-reinforced polymer composite ply comprises the plurality of reinforcement fibers and the polymer resin, and
the at least two layers of the fiber-reinforced polymer composite plies comprise at least one ply having a first ply angle, and at least one ply having a second ply angle which is different from the first ply angle.

11. A method for bonding a thermoplastic-based material to a fiber-reinforced polymer composite comprising:
removing a portion of a polymer resin from the fiber-reinforced polymer composite to expose a portion of a plurality of reinforcement fibers of the fiber-reinforced polymer composite;
heating at least a portion of the thermoplastic-based material to a bonding temperature;
contacting the heated portion of the thermoplastic-based material to the exposed portion of the plurality of the reinforcement fibers and embedding at least a portion of the exposed portion of the plurality of the reinforcement fibers in the thermoplastic-based material, and
cooling the fiber-reinforced polymer composite and the thermoplastic-based material under pressure to an ambient temperature or lower.

12. The method of claim 11, wherein the removing comprises abrading the fiber-reinforced polymer composite.

13. The method of claim 12, wherein the abrading is conducted by an abrasion apparatus comprising a material having a hardness greater than a hardness of the polymer resin and less than a hardness of the plurality of the reinforcement fibers.

14. The method of claim 12, wherein the plurality of the reinforcement fibers is substantially oriented, and the abrading is conducted at an abrasion angle in a range of 0 degrees to 90 degrees with respect to a direction of the substantially oriented reinforcement fibers.

15. The method of claim 12, wherein:
the fiber-reinforced polymer composite comprises at least two layers of fiber-reinforced polymer composite plies,
each fiber-reinforced polymer composite ply comprises the plurality of reinforcement and the polymer resin, and
the at least two layers of the fiber-reinforced polymer composite plies comprise at least one first ply having a first ply angle, and at least one second ply having a second ply angle which is different from the first ply angle.

16. The method of claim 15, wherein the abrading is conducted at an abrasion angle in a range of from 0 to 90 degrees with respect to the first ply angle.

17. The method of claim 16, wherein the removing further comprises abrading the fiber-reinforced polymer composite at an abrasion angle in a range of from 0 to 90 degrees with respect to the second ply angle.

18. The method of claim 11, wherein the heating is conducted after the removing.

19. The method of claim 11, wherein the contacting is conducted for a duration in a range of 30 seconds to 20 minutes.

20. A method for bonding a thermoplastic-based material to a fiber-reinforced polymer composite comprising:
machining a portion of the fiber-reinforced polymer composite to produce a tapered portion having a taper angle of greater than 0 degree and 90 degrees or less;
removing a portion of a polymer resin in the machined portion of the fiber-reinforced polymer composite by abrasion to expose a portion of a plurality of reinforcement fibers comprised in the fiber-reinforced polymer composite;
heating at least a portion of the thermoplastic-based material to a bonding temperature;
contacting the heated portion of the thermoplastic-based material to the exposed portion of the plurality of the reinforcement fibers and embedding at least a portion of the exposed portion of the plurality of the reinforcement fibers in the thermoplastic-based material, and
cooling the fiber-reinforced polymer composite and the thermoplastic-based material under pressure to an ambient temperature or lower.

21. The method of claim 20, wherein:
the fiber-reinforced polymer composite comprises at least two layers of fiber-reinforced polymer composite plies,
each fiber-reinforced polymer composite ply comprises the plurality of reinforcement and the polymer resin, and
the at least two layers of the fiber-reinforced polymer composite plies comprise at least one first ply having a first ply angle, and at least one second ply having a second ply angle which is different from the first ply angle.

22. The method of claim 21, wherein the machining comprises machining a portion of all layers of the at least two layers of the fiber-reinforced polymer composite plies.

23. The method of claim 21, wherein the embedding comprises embedding at least a portion of the exposed portion of the plurality of the reinforcement fibers from at least two layers of the fiber-reinforced polymer composite plies.
